(19) United States
(12) Patent Application Publication
(10) Pub. No.: US 2012/0101855 A1
(43) Pub. Date: Apr. 26, 2012

(54) MONITORING CLIENT-SELECTED VEHICLE PARAMETERS IN ACCORDANCE WITH CLIENT PREFERENCES

(75) Inventors: Dean M. Collins, Manchester, CT (US); John P. O'Connor, Granby, CT (US)

(73) Assignee: THE TRAVELERS INDEMNITY COMPANY, Hartford, CT (US)

(21) Appl. No.: 13/316,754

(22) Filed: Dec. 12, 2011

Related U.S. Application Data
(63) Continuation-in-part of application No. 13/109,449, filed on May 17, 2011.
(60) Provisional application No. 61/345,220, filed on May 17, 2010.

(51) Int. Cl. G06Q 40/08

(52) U.S. Cl. 705/4

(57) ABSTRACT

Business insurance clients select parameters and/or preferences for monitoring in vehicle fleets using one or more telematics devices. The parameters and/or preferences may comprise an operating characteristic associated with fleet vehicles associated with a business insurance product. Selection and measurement of parameters and/or preferences may result in lower insurance premiums. In one embodiment, an apparatus causes, based on a user selection of at least one of a plurality of menu-selectable options, a remotely programmable memory of at least one monitoring device to store an indication of the monitoring parameters and/or preferences represented by the user selection.

### CROSS REFERENCE TO RELATED APPLICATIONS

This application claims benefit and priority (i) under 35 U.S.C. §120 to, and is a Continuation-In-Part (CIP) of, U.S. patent application Ser. No. 13/109,449 filed on May 17, 2011 in the name of Collins et al. and titled “MONITORING CUSTOMER-SELECTED VEHICLE PARAMETERS”, which itself claims benefit and priority under 35 U.S.C. §119(e) of U.S. Provisional Application No. 61/345,220, filed May 17, 2010, entitled “Systems, Methods, and Media for Determining Insurance Premiums Based on Customer-Selected Data Items,” and (ii) under 35 U.S.C. §119(e) to U.S. Provisional Application No. 61/427,201, filed on Dec. 26, 2010 and titled “RISK ZONES”, each of the above-referenced applications of which is incorporated by reference herein in its entirety.

This application is also related to U.S. patent application Ser. No. 13/316,700 filed on Dec. 12, 2011 in the name of Collins et al. and titled “MONITORING CUSTOMER-SELECTED VEHICLE PARAMETERS IN ACCORDANCE WITH CUSTOMER PREFERENCES”, which itself claims priority to U.S. patent application Ser. No. 13/109,418 filed on May 17, 2011 in the name of Collins et al. and titled “MONITORING CUSTOMER-SELECTED VEHICLE PARAMETERS”.

### BACKGROUND

An insurance policy protects a policy owner against contingent losses, such as property loss, property damage, bodily injury, and death, for example. In one example, automobile insurance may protect an automobile owner against losses resulting from auto accidents. To obtain automobile insurance, a customer (e.g., an individual or other client such as a business) pays an insurer a premium and, in return, the insurer agrees to pay losses that the customer incurs, as defined in the terms of an insurance policy.

The amount of the premium may be determined based on various factors. For example, an automobile insurance premium may be based on the age, gender, credit rating, and home address of an insured, and by the distance the automobile is driven within a time period. In some cases, insurance companies may set or adjust automobile insurance premiums based on data determined by monitoring the automobile's operation. In those cases, customers have the ability to opt in or opt out of their insurer's monitoring program.

### BRIEF DESCRIPTION OF THE DRAWINGS

The accompanying drawings, which are incorporated in and constitute a part of this specification, illustrate exemplary embodiments of the invention and, together with the description, serve to explain the principles of the invention. In the drawings,

FIG. 1 is a diagram of a system according to some embodiments;

FIG. 2 is a diagram of a computer according to some embodiments;

FIG. 3 is a diagram of a system according to some embodiments;

FIG. 4A and FIG. 4B are flowcharts of a method according to some embodiments;

FIG. 5 is a flowchart of a method according to some embodiments;

FIG. 6 depicts an example user interface according to some embodiments;

FIG. 7 depicts an example user interface according to some embodiments;

FIG. 8 depicts an example user interface according to some embodiments;

FIG. 9 depicts an example user interface according to some embodiments;

FIG. 10A and FIG. 10B depict an example user interface according to some embodiments;

FIG. 11A and FIG. 11B depict an example user interface according to some embodiments; and

FIG. 12 depicts an example user interface according to some embodiments.

### DETAILED DESCRIPTION

This disclosure relates to systems, media, and methods for determining an insurance premium based on client-selected and/or client-customized data items relating to vehicular operations. In some embodiments, client-selected and/or client-customized data items relating to use of a client's vehicle or vehicles may be monitored, recorded, and/or transmitted to an insurance company, responsive to client control. The insurance company may determine an insurance premium based on values associated with the client-selected data items, alone or in conjunction with other data. In addition, the client may choose, select, and/or update, in real-time, which data items are monitored, recorded, and/or transmitted, and may receive confirmation that the system has been updated based on the client's preferences. The policy itself may or may not be updated (e.g., policy pricing, discounts, surcharges, and/or associated benefits or penalties) immediately to reflect these updates. The client may select different data items to be monitored, recorded, and/or transmitted for different individuals (e.g., employees), vehicles, classes of vehicles, routes (e.g., associated with certain customers of the client), and/or may indicate the vehicle an individual is operating. Different clients may have different restrictions as to the data items they may select or unselect for monitoring, based, for example, on the type of policy and/or client type. The client may be, e.g., an individual, a corporation, a franchise, and/or other business or entity, etc.

As used herein, “automobile” and “vehicle” may be used interchangeably and may generally refer to any type, configuration, and/or quantity of vehicles, such as vehicles of the type typically covered by an automobile insurance policy, a recreational vehicle insurance policy, a boat insurance policy, and other related policies.

As utilized herein, the term “client” may generally refer to any type, quantity, and or manner of entity with or for which policy, telematics, and/or premium information may be determined in accordance with embodiments described herein. A client may comprise an individual, a company, and/or an agent of a company or/or other business insurance policy holder, for example, and/or may comprise an individual, company, agent, and/or other entity that seeks to price and/or obtain an insurance and/or other underwriting policy as described herein. A client may have an existing business relationship with other entities described herein, such as an insurance company for example, or may not yet have such a relationship—i.e., a “client” may comprise a “potential client”.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, LAN, WAN, Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

In cases where video signals or large files are being sent over the network, a broadband network may be used to alleviate delays associated with the transfer of such large files, however, such an arrangement is not required. Each of the devices may be adapted to communicate on such a communication means. Any number and type of machines may be in communication via the network. Where the network is the Internet, communications over the Internet may be through a website maintained by a computer on a remote server or over an online data network, including commercial online service providers, and/or bulletin board systems. In yet other embodiments, the devices may communicate with one another over RF, cable TV, and/or satellite links. Where appropriate, encryption or other security measures, such as logins and passwords, may be provided to protect proprietary or confidential information.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

As used herein, “determining” includes calculating, computing, deriving, looking up (e.g., in a table, database, or data structure), ascertaining, and/or recognizing.

A “processor” means any one or more microprocessors, Central Processing Unit (CPU) devices, computing devices, microcontrollers, and/or digital signal processors. Exemplary processors include the INTEL PENTIUM and AMD ATHLON processors.

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

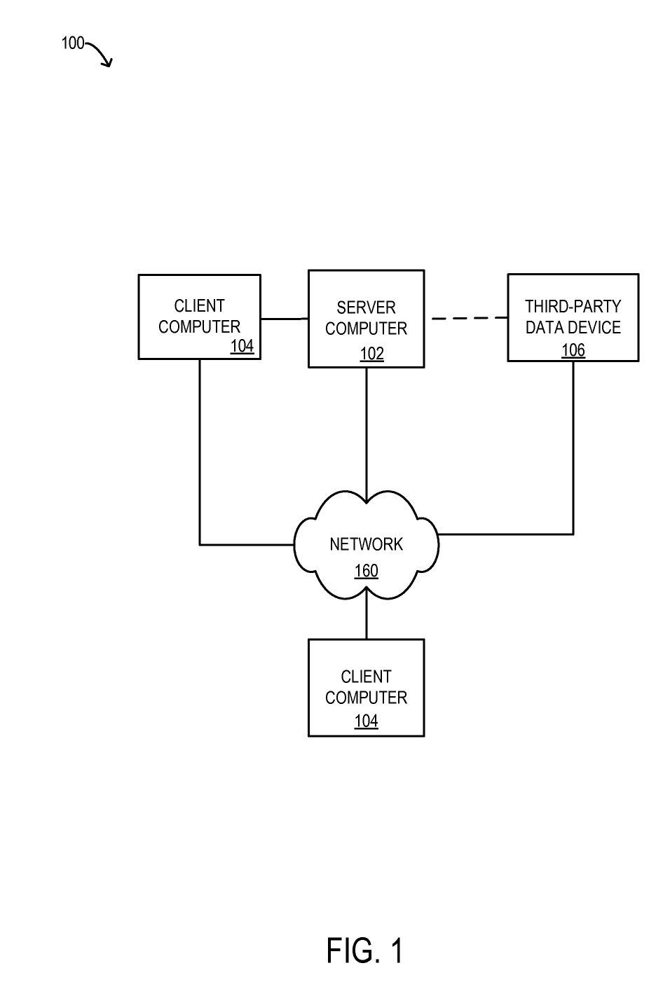

FIG. 1 depicts a block diagram of an example system 100 according to some embodiments. The system 100 may comprise one or more client computers 104 (e.g., operated by one or more clients; not explicitly shown in FIG. 1) in communication with a server computer 102 (e.g., a controller device) via a network 160. Typically a processor (e.g., one or more microprocessors, one or more microcontrollers, one or more digital signal processors) of a client computer 104 or server computer 102 will receive instructions (e.g., from a memory device), and execute those instructions, thereby performing one or more processes defined by those instructions. Instructions may be embodied in, for example, one or more computer programs and/or one or more scripts.

In some embodiments a server computer 102 and/or one or more of the client computers 104 stores and/or has access to data items related to insurance business information. Such information may include insurance data, such as policy data and underwriting rules, for example, and client data, such as demographic data and data relating to use of one or more of the client's vehicles (not shown in FIG. 1), for example.

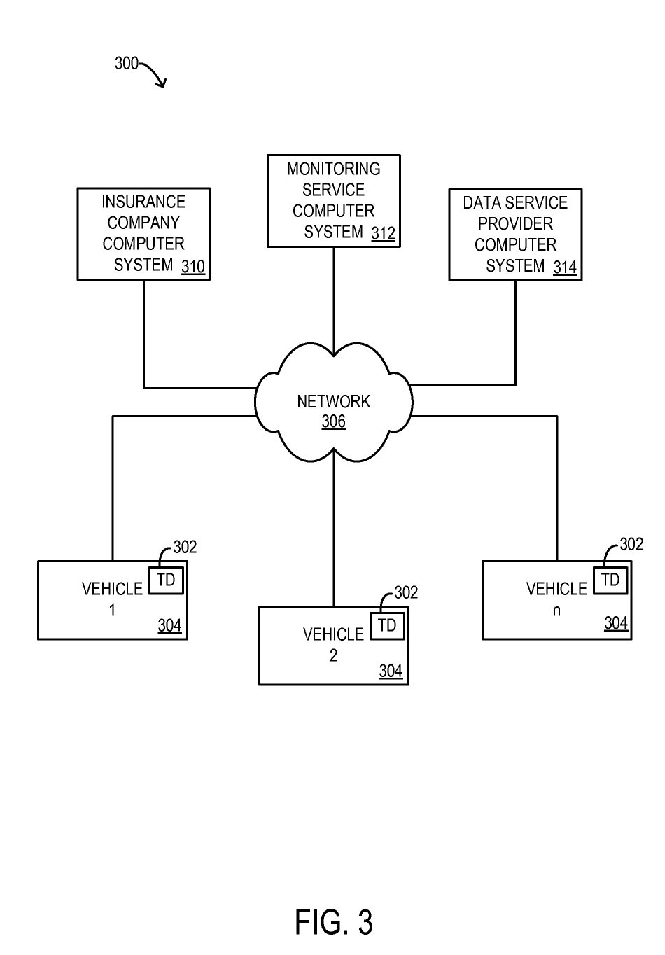

According to some embodiments, any or all of such data may be stored by or provided via one or more optional third-party data devices 106 of the system 100. A third-party data device 106 may comprise, for example, an external hard drive or flash drive connected to a server computer 102, a remote third-party computer system for storing and serving data for use in performing an underwriting function, or a combination of such remote and local data devices. In another example, the third-party data device 106 may comprise one or more telematics devices (such as the telematics devices 302 of FIG. 3 herein) associated with client vehicles, as described hereinafter.

A third-party entity (e.g., a party other than an owner and/or operator, etc., of the server computer 102, client computer 104, and other than an end-user of any data used in the underwriting process) may comprise, without limitation, (i) a third-party vendor, such as a monitoring service, which collects data from a telematics device (such as a telematics device 302 of FIG. 3 herein) associated with a client's vehicle, or a data service provider, which aggregates vehicle data from various sources, a government agency, and/or a regulatory body, (ii) an insurance client, and/or (iii) a demographic data gathering and/or processing firm.

A third-party entity, such as a monitoring service or a data service provider may, for example, collect and/or monitor vehicle data for various purposes deemed useful by the third party, including, without limitation, data mining, data analysis, data aggregation, price tracking, and/or sale or exchange of collected data. In one embodiment, any raw data, data analysis, and/or metrics may be stored on and/or made available (e.g., to an insurer) via the third-party data device 106. In one embodiment, one or more companies and/or end users may subscribe to or otherwise purchase data (e.g., vehicle data) from a third party and receive the data via the third-party data device 106. Such data may include vehicle data that has been measured or otherwise monitored, as well as data associated with vehicle identification numbers, claim history data, and/or data from state or federal government sources, such as motor vehicle departments, for example. Accordingly, in some embodiments, data from third-party sources, such as government and/or commercial entities, could be stored on, received from, and/or made accessible via third-party device(s) 106.

In some embodiments, the server computer 102 may store underwriting rules for writing and/or pricing insurance policies, and/or the client computer 104 may execute the application remotely via the network 160 and/or download from the server computer 102 (e.g., a web server) some or all of the program code for executing one or more of the various embodiments described herein.

In one embodiment, a server computer 102 may not be necessary or desirable. For example, some embodiments may be practiced on one or more devices without a central authority. In such an embodiment, any functions described herein as performed by a server computer 102 and/or data described as stored on a server computer 102 may instead be performed by or stored on one or more such devices. Additional ways of distributing information and program instructions among one or more client computers 104 and/or server computers 102 will be readily understood by one skilled in the art upon contemplation of the present disclosure.

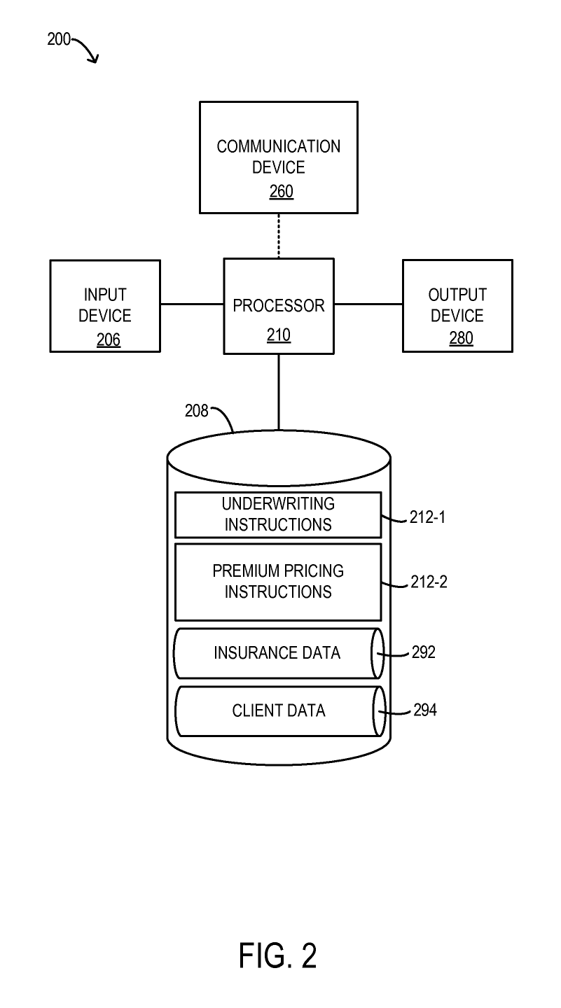

FIG. 2 depicts a block diagram of an apparatus 200 according to one embodiment. In some embodiments, the apparatus 200 may be similar in configuration and/or functionality to any of the client computers 104, server computers 102, and/or third-party data devices 106 of FIG. 1. The apparatus 200 may, for example, execute, process, facilitate, and/or otherwise be associated with any of the processes described herein. In some embodiments, the apparatus 200 may comprise an input device 206, a memory device 208, a processor 210, a communication device 260, and/or an output device 280. Fewer or more components and/or various configurations of the components 206, 208, 210, 260, 280 may be included in the apparatus 200 without deviating from the scope of embodiments described herein.

According to some embodiments, the processor 210 may be or include any type, quantity, and/or configuration of processor that is or becomes known. The processor 210 may comprise, for example, an Intel® IXP 2800 network processor or an Intel® XEON™ Processor coupled with an Intel® E7501 chipset. In some embodiments, the processor 210 may comprise multiple inter-connected processors, microprocessors, and/or micro-engines. According to some embodiments, the processor 210 (and/or the apparatus 200 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 200 comprises a server such as a blade server, necessary power may be supplied via a standard AC outlet, power strip, surge protector, and/or Uninterruptible Power Supply (UPS) device.

In some embodiments, the input device 206 and/or the output device 280 are communicatively coupled to the processor 210 (e.g., via wired and/or wireless connections and/or pathways) and they may generally comprise any types or configurations of input and output components and/or devices that are or become known, respectively.

The input device 206 may comprise, for example, a keyboard that allows an operator of the apparatus 200 to interface with the apparatus 200, for example, by an insurance client or an insurance agent, such as to select parameters for monitoring by a telematics device (such as a telematics device 302 of FIG. 3 herein). In some embodiments, the input device 206 may comprise a sensor configured to provide information such as encoded measurement parameter data, vehicle data, or other client information to the apparatus 200 and/or the processor 210.

The output device 280 may, according to some embodiments, comprise a display screen and/or other practicable output component and/or device. The output device 280 may, for example, provide information relating to premium discounts and/or surcharges, as well as information relating to premiums associated with one or more parameters and/or preferences a client has selected for monitoring. According to some embodiments, the input device 206 and/or the output device 280 may comprise and/or be embodied in a single device such as a touch-screen monitor.

In some embodiments, the communication device 260 may comprise any type or configuration of communication device that is or becomes known or practicable. The communication device 260 may, for example, comprise a Network Interface Card (NIC), a telephonic device, a cellular network device, a router, a hub, a modem, and/or a communications port or cable. In some embodiments, the communication device 260 may be coupled to provide data to a telecommunications device. The communication device 260 may, for example, comprise a cellular telephone network transmission device that sends signals (e.g., client information, vehicle information, and/or a client's selection of monitored vehicle parameters and/or monitoring preferences) to a server in communication with a plurality of handheld, mobile, smart phone, and/or other telephone devices. According to some embodiments, the communication device 260 may also or alternatively be coupled to the processor 210. In some embodiments, the communication device 260 may comprise an IR, RF, Bluetooth™, Near-Field-Communication (NFC), and/or Wi-Fi® network device coupled to facilitate communications between the processor 210 and another device (such as one or more client computers, server computers, central controllers, and/or third-party data devices).

The memory device 208 (e.g., a computer-readable medium and/or computer-readable memory device) may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

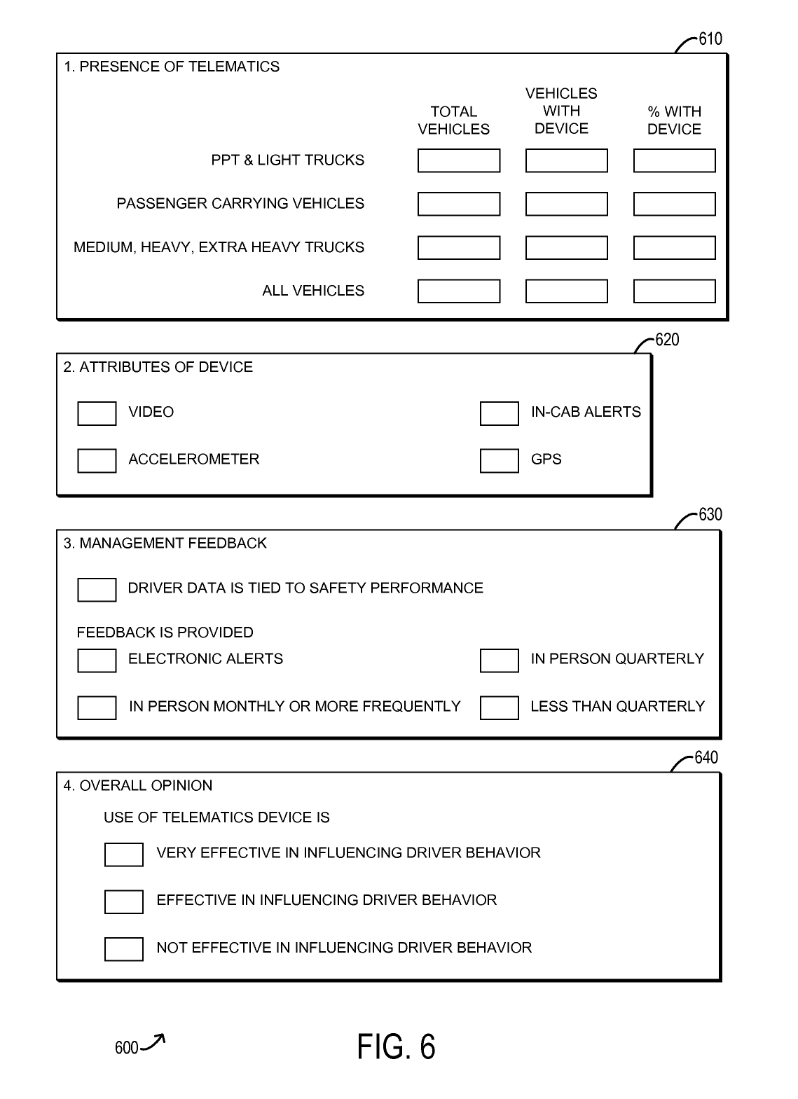

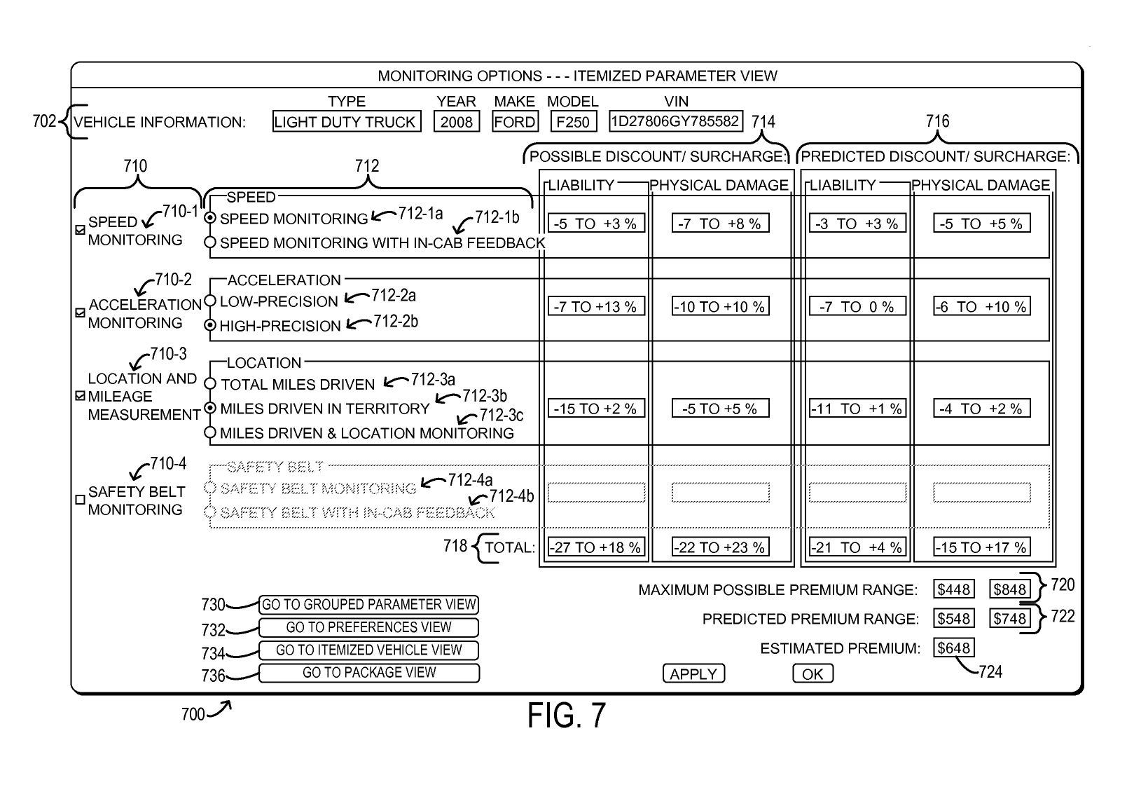

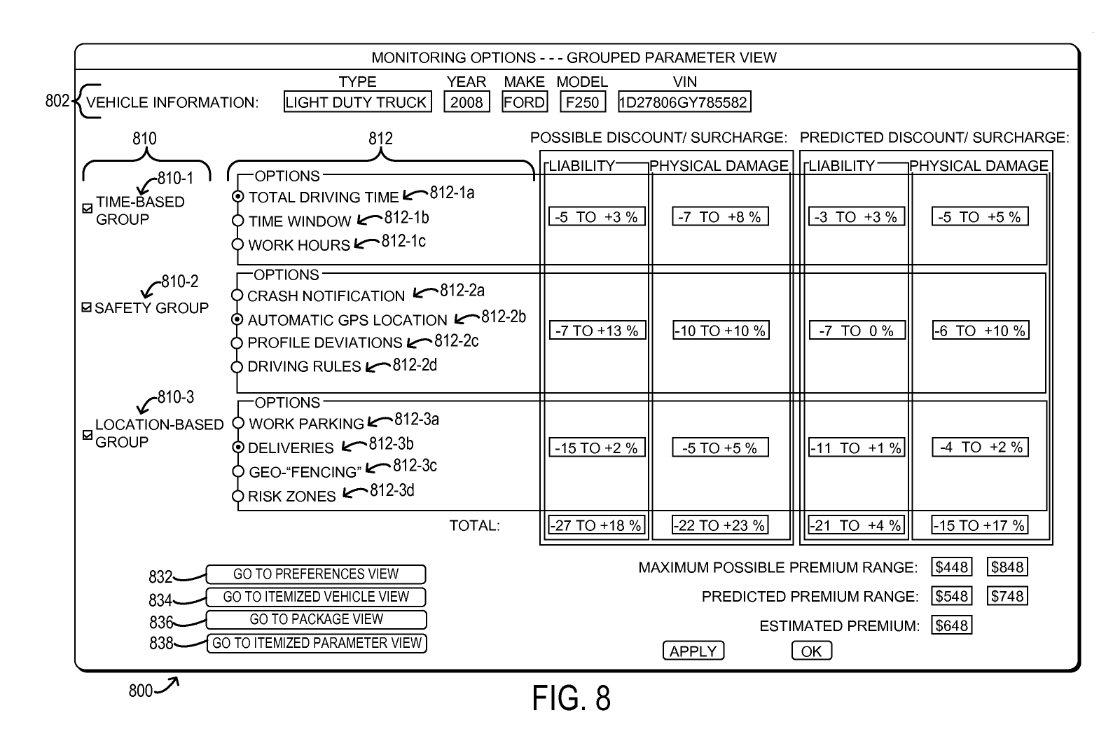

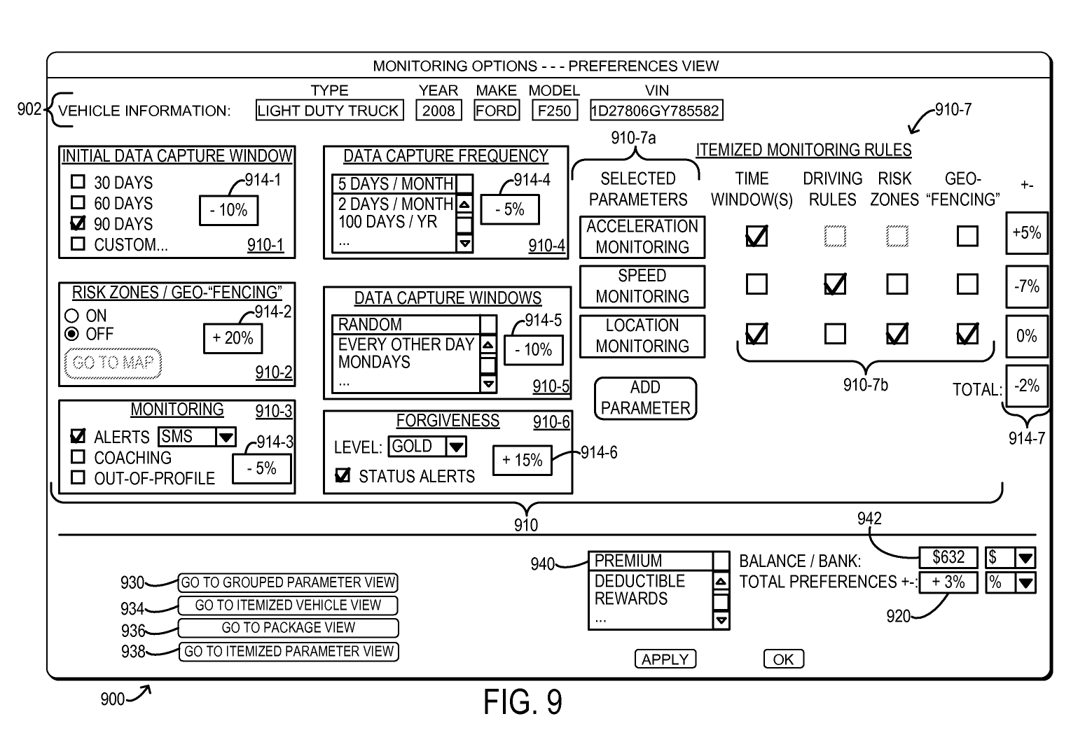

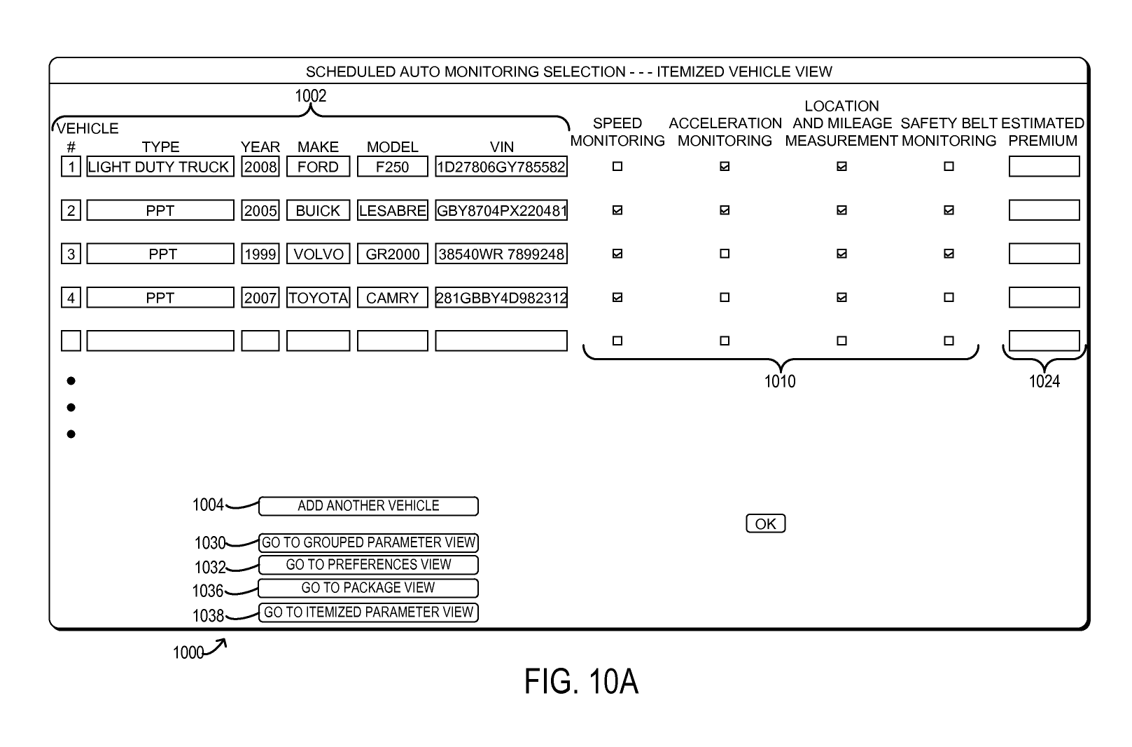

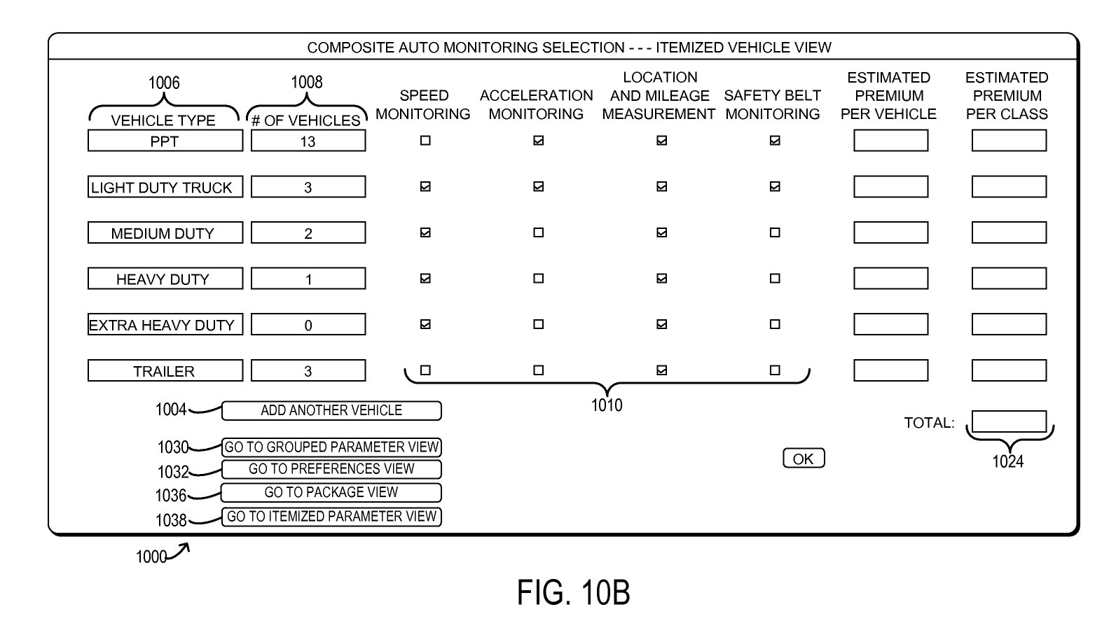

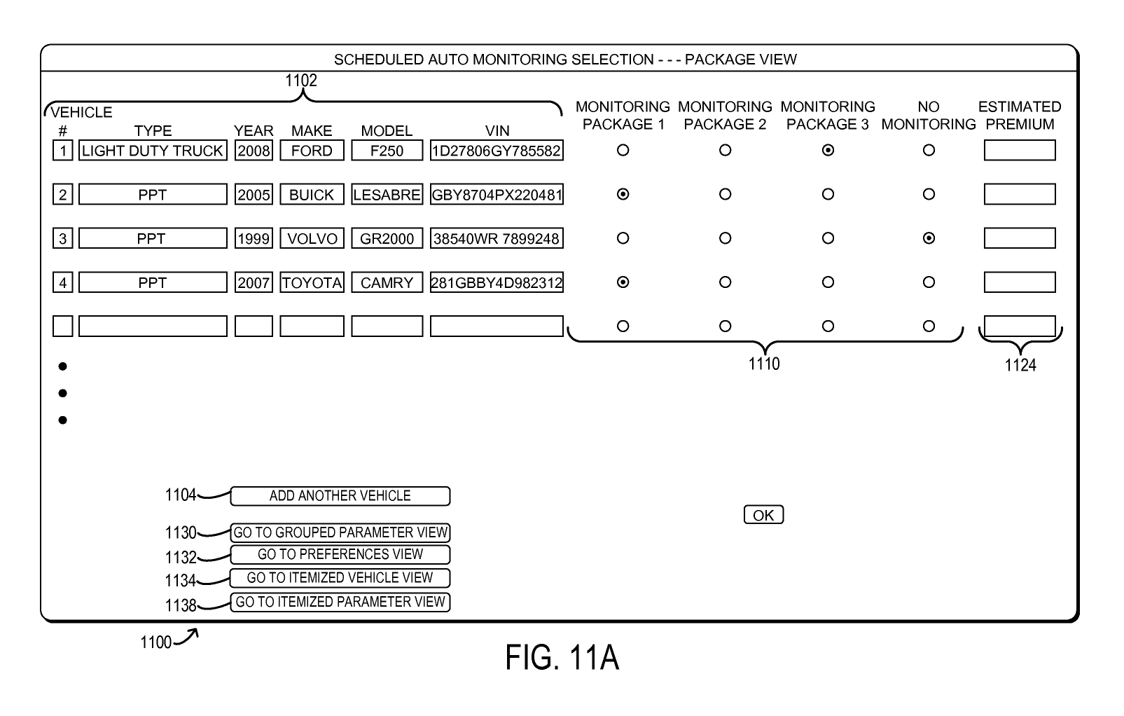

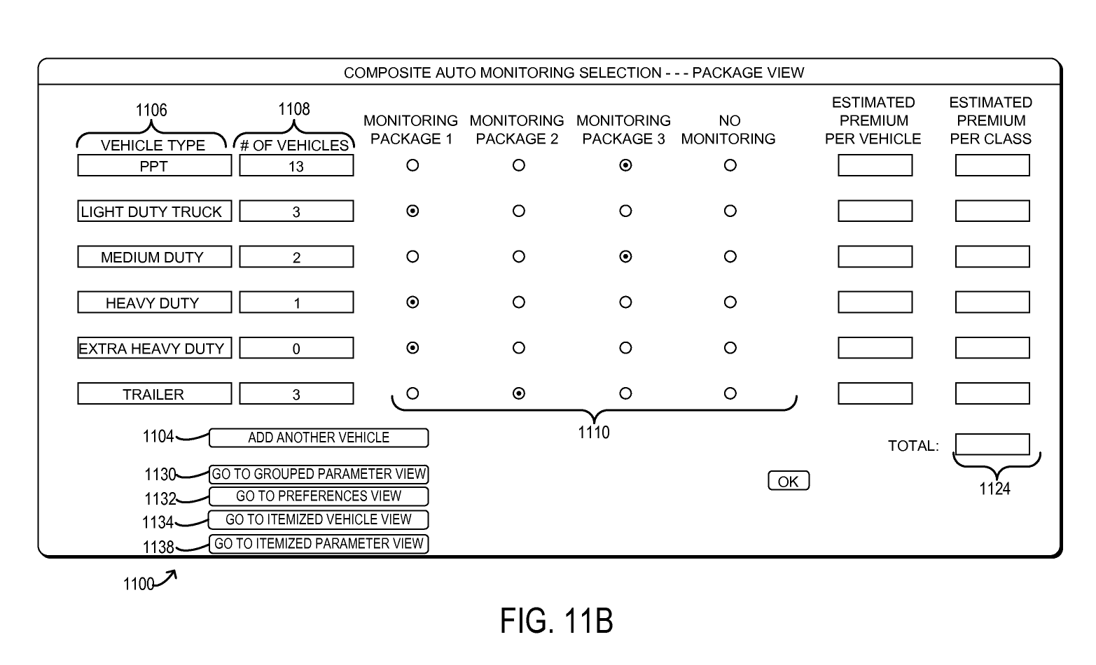

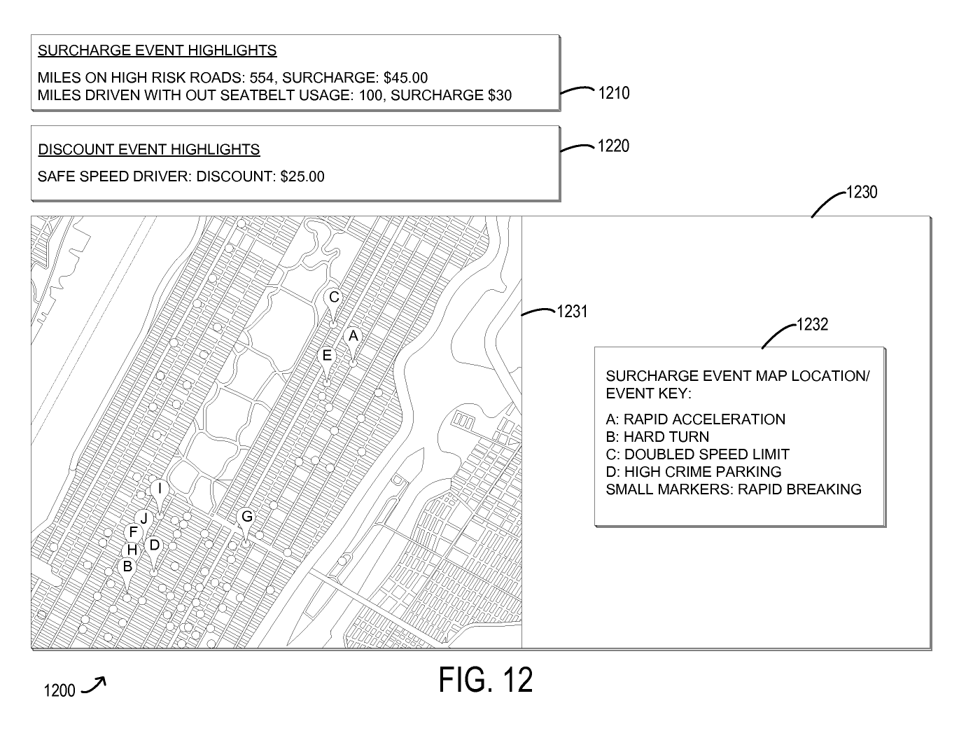

The memory device 208 may, according to some embodiments, store one or more of underwriting instructions 212-1, premium pricing instructions 212-2, insurance data 292, and/or client data 294. In some embodiments, the underwriting instructions 212-1 and/or the premium pricing instructions 212-2 may be utilized by the processor 210 to provide output information via the output device 280 and/or the communication device 260 (e.g., via associated user interfaces, such as the example user interfaces 600, 700, 800, 900, 1000, 1100, 1200 of FIG. 6, FIG. 7, FIG. 8, FIG. 9, FIG. 10A, FIG. 10B, FIG. 11A, FIG. 11B, and/or FIG. 12 herein).

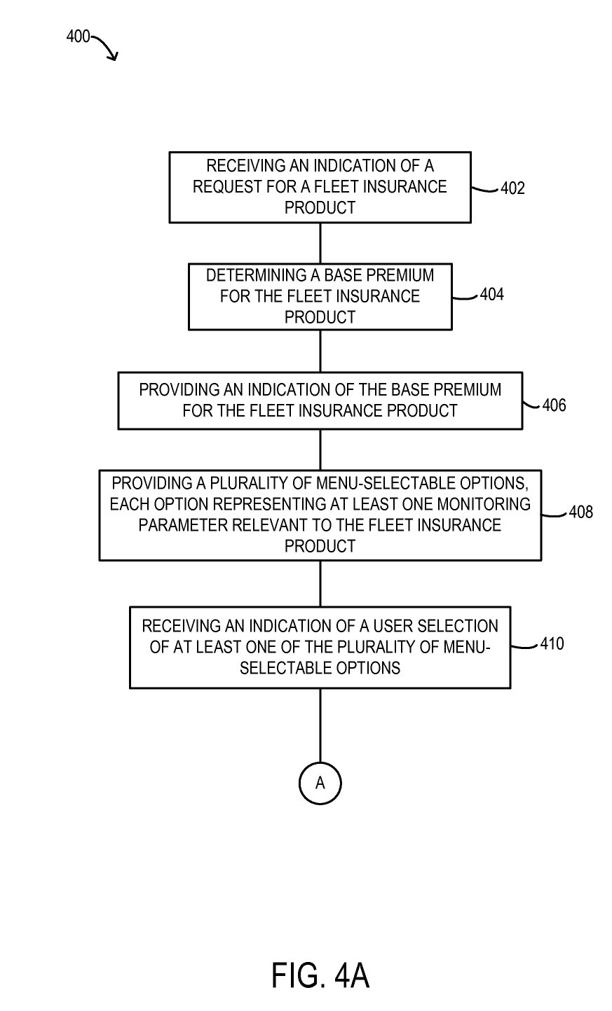

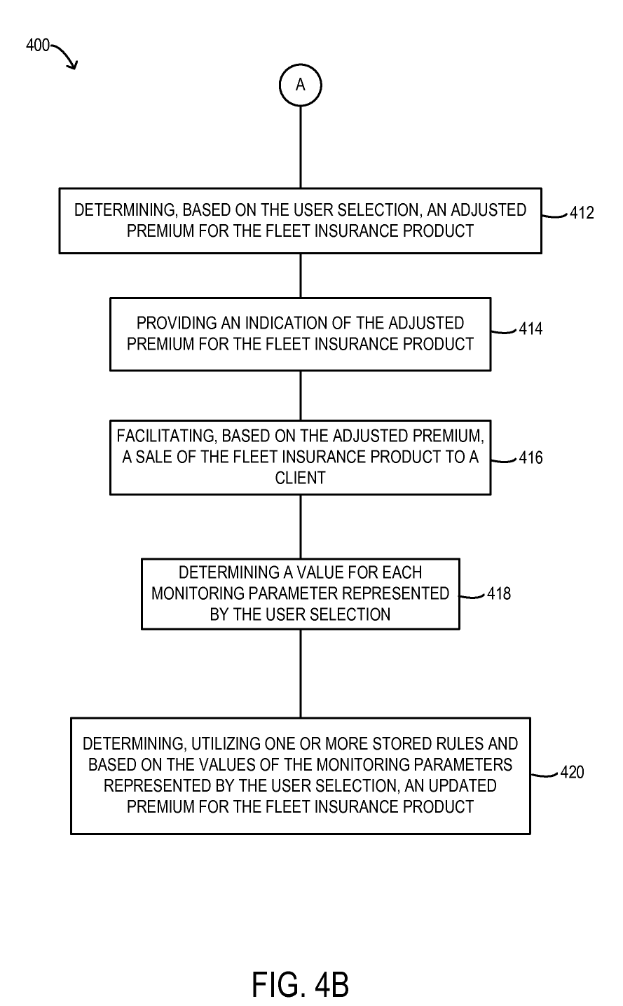

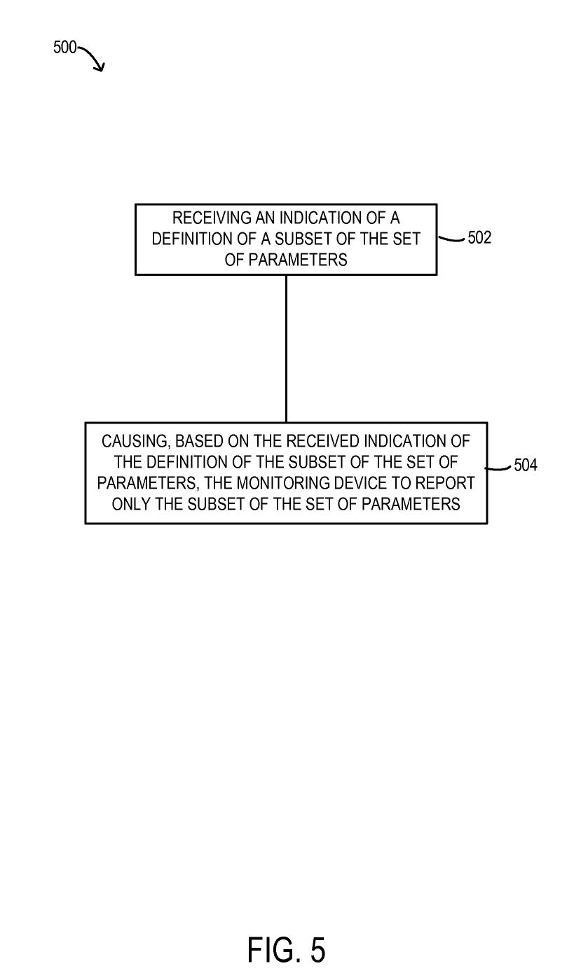

According to some embodiments, the underwriting instructions 212-1 may be operable to cause the processor 210 to process the insurance data 292 and/or the client data 294 in accordance with embodiments described herein. Insurance data 292 and/or client data 294 received via the input device 206 and/or the communication device 260 may, for example, be data mined, analyzed, sorted, filtered, decoded, decompressed, ranked, scored, plotted, and/or otherwise processed by the processor 210 in accordance with the underwriting instructions 212-1 (e.g., in accordance with the methods 400, 500 of FIG. 4A, FIG. 4B, and/or FIG. 5 herein). In some embodiments, insurance data 292 and client data 294 may be fed by the processor 210 through one or more mathematical and/or statistical equations and/or models in accordance with the underwriting instructions 212-1 and/or premium pricing instructions 212-2 to define one or more discounts and/or surcharges that may then be utilized to provide premiums associated with one or more parameters that a client has selected for monitoring.

According to some embodiments, the premium pricing instructions 212-2 may be operable to cause the processor 210 to perform a risk assessment (e.g., for an automobile fleet insurance policy) in accordance with embodiments described herein. Insurance data 292 and/or client data 294 may be analyzed to generate discounts and/or surcharges associated with parameters selected by the client for monitoring and/or preferences for such monitoring, such as by a telematics device (e.g., the telematics devices 302 of FIG. 3 herein), for example. The underwriting instructions 212-1 and/or the premium pricing instructions 212-2 may, in some embodiments, utilize the insurance data 292 and/or the client data 294 to provide an indication that an insurance policy should not be written or that a policy should be given a discount and/or a surcharge.

The apparatus 200 may function as a computer terminal and/or server of an insurance company that is accessible by an insurance agent and/or a client, for example, and is utilized to determine discounts, surcharges, and/or premiums associated with one or more parameters that a client has selected for monitoring and/or in accordance with preferences the client has selected in relation to and/or defining how such monitoring should or shall occur. In some embodiments, the apparatus 200 may comprise a web server and/or other portal (e.g., an Interactive Voice Response Unit (IVRU)) that provides information on insurance policy discounts, surcharges, and/or premiums to users, agents, and/or clients.

Any or all of the exemplary instructions and data types described herein and other practicable types of data may be stored in any number, type, and/or configuration of memory devices that is or becomes known. The memory device 208 may, for example, comprise one or more data tables or files, databases, table spaces, registers, and/or other storage structures. In some embodiments, multiple databases and/or storage structures (and/or multiple memory devices 208) may be utilized to store information associated with the apparatus 200. According to some embodiments, the memory device 208 may be incorporated into and/or otherwise coupled to the apparatus 200 (e.g., as shown) or may simply be accessible to the apparatus 200 (e.g., externally located and/or situated).

FIG. 3 illustrates an exemplary telematics data system 300, in which telematics data is transmitted from a telematics device 302 in each of one or more vehicles 304 through a network 306 to an insurance company computer system 310 and, optionally, to one or more of a monitoring service computer system 312, and a data service provider computer system 314. The computer systems 310, 312, 314 may have an arrangement similar to the exemplary system 100 of FIG. 1 and/or may contain one or more apparatuses similar to the exemplary apparatus 200 of FIG. 2 herein. Other arrangements may also or alternatively be utilized. Further, the exemplary telematics data system 300 depicts three vehicles 304, but it is understood that such systems 300 according to embodiments may include fewer or more vehicles 304, including 304 vehicles of various types (e.g., a fleet of vehicles), as is or becomes desirable and/or practicable.

In one embodiment, telematics data is transmitted directly to the insurance company computer system 310, where the data is processed and analyzed (e.g., for insurance underwriting, modeling, quotation, quality review, risk analysis, loss analysis, and/or other purposes). In another embodiment, the data is transmitted first to a monitoring service computer system 312 where it is processed. The processed data is then transmitted to the insurance company computer system 310 where it is analyzed. In yet another embodiment, the telematics data is transmitted from the monitoring service computer system 312 to the data service provider computer system 314, where it is combined with other data, e.g., including third-party data, before being transmitted to the insurance company computer system 310. In other embodiments, the telematics data may be transmitted to one or more of the computer systems 310, 312, 314 simultaneously.

According to embodiments, a client (not explicitly shown in FIG. 3) may select the data items that are monitored by the telematics device 302, and ultimately by the insurance company, and/or how such data items are to be monitored. Selection of data items and/or monitoring preferences by the client may allow the client to control the extent and/or nature of his or her discount, while overcoming any privacy restrictions that limit monitoring of confidential information by third parties. In one embodiment, the telematics device 302 may be configured to transmit only those data items selected by the client and/or to only transmit such data items in accordance with any preferences and/or rules selected and/or otherwise defined by the client. In another embodiment, the telematics device 302 may transmit a set of data items to a third-party, such as a monitoring service or a data service provider, for example, but only the client-selected data items may be provided by the third-party to the insurance company, and/or they may only be provided in accordance with client preferences (e.g., they may be filtered based on client-defined or selected rules). In yet another embodiment, the telematics device 302 may transmit a full set of client data to the insurance company, directly or via a third-party, and the insurance company may utilize only the client-selected data items and/or may utilize the client-selected preferences for determination of the client's premium, discounts, surcharges, rewards, and/or penalties. Other arrangements may also be utilized as is or becomes desirable and/or practicable.

In some embodiments, the telematics device 302 may measure the data items directly from the vehicle 304. In one example, the telematics device 302 may communicate with the vehicle's On-Board Diagnostic (OBD) computer (not explicitly shown in FIG. 3), such as through the OBD port (e.g., OBD-II port) or comparable electrical connection. Such systems may allow the direct measurement of many aspects of the vehicle 304 and operation thereof. Other connections allowing direct vehicle measurements may also or alternatively be utilized. In such embodiments, the data may be actively transmitted by the telematics device 302 or it may be read from the telematics device 302, such as by an RFID and/or NFC scanner or other scanner (which are not depicted in FIG. 3), for example, as the vehicle 304 passes by and/or comes within proximity of the scanner.

In other embodiments, the telematics device 302 may provide information regarding the vehicle 304 and/or its operation by being present in the vehicle 304 and transmitting a signal while the vehicle 304 is operated without a connection to any vehicle system. In one example, such a telematics device 302 may comprise one or more of a Global Navigation Satellite System (GNSS) device, such as a Global Positioning System (GPS) device, a mobile phone or personal portable electronic device, an accelerometer, an RFID device, a trailer tracking device, and/or an intelligent vehicle device. Such devices 302 may be removably or fixedly mounted in the vehicle 304. In some embodiments, the monitoring service may be provided, for example, by the client's mobile service and/or tracking provider (e.g., cell phone provider, 3G data service provider, fleet tracking and/or management provider, etc.).

Still other embodiments may include telematics devices 302 that both measure vehicle parameters directly, as well as provide data by being present in the vehicle 304.

In some embodiments, certain data items may be determined indirectly, i.e., through other data items. For example, the amount of time a vehicle 304 spends in traffic may be determined using a combination of third-party data (e.g., posted speed limit) and measured speed and/or analysis of speed data (e.g., slow, frequent start/stop, etc.).

The telematics device 302 may include a remotely programmable memory (e.g., for designating the data items to monitor, record, and/or transmit, and/or for defining rules and/or preferences that govern how and/or when such data should be monitored, recorded, and/or transmitted), as well as various interfaces for wireless and/or hard-wired communications (e.g., for monitoring various aspects of driving and/or for communicating the monitored data items).

Telematics device vendors may comply with the data standard set by the insurance company or by industry standards organizations, such as the Association for Cooperative Operations Research and Development (ACORD), for example. In some embodiments, once the vendor indicates which standards of data transfer it will support, it may offer those options to the client, who in turn may decide which transfer mode to use with the insurance company.

In some embodiments, all data from a given telematics device 302 may be monitored. For example, if accelerometer data is to be included, then that data may be used for any purpose, such as for detecting braking, swerving, acceleration, etc. In other embodiments, however, the client may specify the types of behaviors to monitor. For example, although an accelerometer may be used to monitor both braking and swerving, a client may choose to have one monitored and not the other. In another example, although GPS data may be used for multiple monitoring purposes, such as location, speed, time of day, etc., the client may specify one or more specific data items to be monitored by GPS. In some embodiments, data to be monitored by the telematics device 302 may be governed by various rules and/or preferences. The accelerometer and/or GPS data may be recorded and/or tracked during certain time windows, with certain frequencies of measurement, with certain precision of measurement, and/or with respect to certain geographic parameters, that may, for example, be selected and/or defined by a client (and/or third-party or insurer).

In addition, for each client-selected data item, more than one method/device may be used to monitor the selected data item. For example, if the client approved monitoring of speed, such monitoring may be achieved through different sources, such as the OBD connector to the vehicle computer and/or GPS data. In some embodiments, both may be considered approved by the client under the speed-monitoring authorization.

As described herein, embodiments of may allow a client to select the parameters (e.g., data items) monitored by an insurance company on which the client's premium is based, instead of merely allowing the client to opt in or opt out of a monitoring program. Also as described herein, embodiments may allow the client to select how and/or when monitored parameters and/or data items (selected for monitoring by the client, or otherwise) may be monitored, recorded, and/or transmitted.

An embodiment of a method 400 according to some embodiments is described with reference to FIG. 4A and FIG. 4B. As shown, the method 400 may comprise, at 402, receiving (e.g., by a specially-programmed computer device and/or from a user device) an indication of a request for an insurance product (such as a business insurance product). The method 400 of this embodiment may further comprise, at 404, determining (e.g., by the specially-programmed computer device) a base premium for the requested insurance product. The base premium for the requested insurance product (and/or an indication thereof) may be provided in some embodiments, at 406, such as to a client, for example.

In one embodiment, the insurance product may comprise a business insurance product. As utilized herein, “business insurance” generally relates to insurance policies owned by one or more individuals (e.g., Doing-Business-As (DBA) entities and/or sole-proprietors) in their professional and/or business capacity and/or in association or affiliation with a business or other organization or entity, and not, for example, for personal or family purposes

According to some embodiments, the method 400 may comprise providing a plurality of menu-selectable options, each option representing at least one monitoring parameter relevant to the requested insurance product at 408. The menu-selectable options may be provided, for example, to a client who has purchased or may purchase an insurance product. (e.g., during an underwriting and/or quotation process). According to some embodiments, the monitoring parameters may comprise various driver, environmental, and/or vehicle data items such as, but not limited to, heart rate, respiration rate, head position (e.g., for determining “asleep-at-the-wheel” conditions), temperature, weather conditions, road conditions, traffic conditions, speed, acceleration, location, orientation, weight, fuel quantity (gas, diesel, Compressed Natural Gas (CNG), fuel cell, and/or battery charge/electricity) and/or engine or motor parameters. According to some embodiments, the monitoring parameters may also or alternatively comprise various preferences and/or rules regarding how and/or when various data items should be monitored, stored, recorded, transmitted, etc. For example, a client may define and/or select one or more time windows, monitoring frequencies, geographic locations, barriers, and/or regions, and/or other parameters that govern and/or trigger data item monitoring, storing, recording, transmitting, and/or analysis. In some embodiments, the method 400 may comprise receiving an indication of a user selection of at least one of the plurality of menu-selectable options, at 410. The indication at 410 may be received, for example, via one of the example interfaces 600, 700, 800, 900, 1000, 1100, 1200 of FIG. 6, FIG. 7, FIG. 8, FIG. 9, FIG. 10A, FIG. 10B, FIG. 11A, FIG. 11B, and/or FIG. 12 herein and/or via one or more of the components thereof (e.g., parameter-specific interface features).

In some embodiments, the method 400 may proceed, as shown at “A” in FIG. 4A, to “A” in FIG. 4B. In one embodiment, the method 400 may comprise determining, based on the user selection, an adjusted premium for the requested insurance product, at 412. The method 400 may, according to some embodiments, comprise providing an indication of the adjusted premium for the requested insurance product, at 414.

In one embodiment, the adjusted premium may comprise at least one of a presently discounted premium and an estimated future discounted premium. For example, some insurance programs provide incentives, such as discounts, for merely participating. Thus, once a user (e.g., a client) selects one or more menu-selectable items for monitoring, that user may obtain a discount. In other insurance programs, discounts are not provided until a client's driving characteristics have been monitored and found to be lower risk characteristics. In those cases, the adjusted premium may comprise an indication of a possible or predicted discount (e.g., a range of potential discount or other incentive levels).

In an embodiment, the method 400 may comprise facilitating, based on the adjusted premium, a sale of the requested insurance product to a client, at 416. As utilized herein, “sale” may generally relate to the purchase of a policy by a new client. It may also relate to the conversion or renewal of a policy by an existing client. The method 400 may comprise, in some embodiments, determining a value for each monitoring parameter represented by the user selection, at 418. Insurance premium discounts and/or surcharges, and/or other rewards and/or penalties may be based on (e.g., looked-up and/or calculated utilizing) information regarding which parameters the client desires to have monitored and/or based on what preferences the client establishes regarding how parameters should be monitored (and/or otherwise utilized).

In one embodiment, the method 400 may comprise, at 420, determining, utilizing one or more stored rules and based on the values of the monitoring parameters represented by the user selection, an updated premium for the requested insurance product. According to an embodiment, the updated premium may comprise one of a discounted premium and a surcharged premium. For example, if a client's driving characteristics (and/or characteristics of one or more drivers employed by or otherwise associated with business operation of the client) are monitored and are found to be low risk, that client may be given a discounted premium. On the other hand, if the client (and/or driver(s) associated with the client's business) are found to exhibit high-risk driving characteristics, the client is likely to receive a surcharged premium.

According to some embodiments, instead of merely opting in or opting out of a monitoring program, a client may select which monitoring parameters (i.e., data items) his insurance premium will be based on and/or how and/or when such parameters should be utilized. In one example, a client may enroll in a fleet vehicle insurance program and select the monitoring parameters to be monitored and/or for what timeframes, frequencies, and/or for what geographic locations such parameters should be monitored. An insurance premium may be calculated at least in part on the monitoring parameters and/or associated preferences that were selected (and/or defined) by the client. For example, the insurance premium may be based on monitored values associated with the monitoring parameters and/or merely the client's selection of certain data items and/or monitoring preferences thereof.

As described with reference to FIG. 3, the monitoring of a vehicle, according to embodiments, may be performed in various ways by various entities. For example, a telematics device 302 may be installed in a client's vehicle 304 and may be monitored remotely by an insurance company computer system 310. In some embodiments, the telematics device 302 may be monitored by a monitoring service computer system 312, which relays the monitored information to the insurance company computer system 310. In some embodiments, a data service provider may, for example, aggregate data from various sources and send the aggregated data to the insurance company computer system 310. For example, the data service provider may receive the monitored data items from monitoring service computer system 312 as well as other information from, for example, a state division of motor vehicles, credit agencies, other monitoring services, a fleet manager, client reports, the federal government, etc. In some embodiments, the data service provider computer system 314 may filter out certain data items received from the monitoring service computer system 312. This filtering may be controlled, e.g., based on one or more of the identities of various parties (e.g., the client, a driver of the client, a vehicle of the client, the monitoring service, the data service provider, and/or the insurance company) or based on any other options or data items that the parties select.

Turning to FIG. 5, a flowchart of a method 500 according to some embodiments is shown. In some embodiments, the method 500 may comprise receiving an indication of a definition of a subset of the set of parameters, at 502. The method 500 may also comprise causing, based on the received indication of the definition of the subset of the set of parameters, the monitoring device to report only the subset of the set of parameters, at 504.

The monitoring parameters presented to a client for selection may, in some embodiments, depend on the type of telematics device 302 the client is utilizing. For example, if a client utilizes only a GPS device, the client may be able to monitor either or both of speed and acceleration, but may not able to select airbag deployment monitoring. The options presented to a client for selection may depend on information relating to the client and/or one or more vehicles of the client. For example, the available data items may depend on records retrieved from a state division of motor vehicles database or a database of the insurance company based on the vehicle's Vehicle Identification Number (VIN) or the client's identification (e.g., driver license number, Federal Employment Identification Number (FEIN), business ID, trademark, and/or account identifier). If, for example, the vehicle records indicate the vehicle includes a Tire Pressure Monitoring System (TPMS) that may be monitored, the client may be presented with the option to include tire pressure among the monitored data items. In another example, if the client has many speeding violations (or, for example, Better Business Bureau (BBB) and/or other complaints), the insurance company may require the client to allow his speed to be monitored (e.g., for one or more drivers and/or vehicles associated with the client) as a condition for being insured through a telematics-based policy, or to receive a discount or qualify for a discount program for the policy.

In the context of a fleet of vehicles (e.g., and/or a business insurance product), the data items made available for selection may depend on the types of telematics devices the various vehicles making up the fleet are utilizing. FIG. 6 depicts an example form view user interface 600 that may be provided, e.g., to a current or prospective corporate client with a fleet of vehicles. The interface 600 may be provided and completed electronically utilizing, e.g., a client or agent computer. In some embodiments, in a first section 610, the client may identify the number of vehicles in different categories it desires to insure and/or the number of those vehicles that have a telematics device. Based on these numbers and types of vehicles, according to some embodiments, an insurance company may determine whether or how it is willing to insure or price the fleet under a telematics monitoring insurance policy. For example, the insurance company may require that a predetermined portion, such as sixty percent (60%), for example, of the vehicles in the fleet have a telematics device for the fleet to qualify, and/or may also require a predetermined portion of vehicles with telematics devices within the different classes of vehicles.

In some embodiments, in a second section 620, the client may indicate one or more attributes of the telematics device installed in the vehicles. This information may be collected on a per vehicle or per subset of vehicles basis, as desired, if different vehicles have different devices. Based on the information collected in the first section 610 and/or the second section 620, the insurance company may decide whether the fleet qualifies for a telematics-based insurance policy and/or what monitoring parameters may be selected for monitoring. According to some embodiments, a third section 630 and/or a fourth section 640 may be utilized to collect additional information from the client that may be utilized, for example, in further tailoring the future selection of monitoring parameters. In some embodiments, the interface 600 of FIG. 6 may be utilized to verify that records of the insurance company accurately reflect the composition of the client's fleet.

According to some embodiments, the selection of monitoring parameters may be separated in steps performed by various clients or users of a vehicle. In the business insurance context, such as in a corporation having a fleet of vehicles, for example, a manager may choose to have certain data items monitored when a first driver utilizes a certain vehicle, while other drivers may have different data items monitored when they use the vehicle. In one embodiment, the telematics device 302 may include a user input device, such as a keypad, for example, with which a driver may identify who (e.g., corporate driver identifier) is driving. The device 302 may also or alternatively include a monitoring device, such as a biometric system or an RFID tag in a key or other device, to determine who is driving the vehicle. This capability may apply, e.g., to those drivers covered under the policy and those who are not and may be renting/leasing the vehicle. In addition, an individual fleet driver may drive different vehicles. The parameters that are monitored may depend on which vehicle an individual fleet driver is driving. Moreover, a manager may choose to have different data items monitored, depending on different vehicle-driver combinations. In some embodiments, rules associated with the parameters to be monitored may be defined, selected, and/or stored (e.g., by the client). Vehicle speed may be monitored (e.g., as a required parameter or as selected by a client), for example, only during certain time windows such as certain days of the week (e.g., workdays or weekends), certain times of the day (e.g., during work and/or commuting hours, during daylight hours, and/or during nighttime hours), and/or during certain seasons (e.g., winter driving). Similarly, parameters (such as speed) may only be monitored if certain conditions are met, such as, but not limited to, certain geographic conditions (e.g., a driver and/or vehicle is located in a particular area, zone, road, structure, or garage), certain environmental conditions (e.g., road conditions and/or weather conditions), and/or certain other conditions (such as legal conditions (e.g., commercial driving laws), regulatory conditions (e.g., roadway vehicle type restrictions), and/or analytical conditions (e.g., deviations from a driver and/or vehicle profile)).

In some embodiments, a client (e.g., a company, organization, government, etc.) may organize its vehicles into fleets. For example, a delivery company may have a first fleet of large delivery vehicles, a second fleet of small delivery vehicles, and third fleet of cars for sales staff, for example. The company may arrange its monitoring program on a per fleet basis. For example, the company may choose to have mileage, location, and speed monitored on the fleet of large delivery vehicles, but only mileage and speed monitored on the fleet of cars for sales staff, because, for example, the sales staff cars may double as personal vehicles for the sales staff during their off-work hours and, thus, location may not be tracked due to privacy concerns. In some embodiments, companies may choose how much data to send (e.g., between a limited data set, a medium-sized data set, and a large data set) to qualify for different tiered discount programs. These differences may affect both driver risk determination and fleet, or fleet safety program assessment and determination, for example. In some embodiments, the monitoring of the parameters (e.g., location) may affect the subsidiary of the insurance company to which the insurance company is underwritten.

The monitoring parameters and/or monitoring rules or preferences may be combined in various ways for use in determining the insurance premium and/or other insurance services (e.g., risk control services). For example, a percentage discount or surcharge may be associated with each parameter and/or preference, and the percentages of each selected parameter/preference may be combined together to obtain a total percentage discount that will be deducted from or added to what would otherwise be the client's premium, i.e., the “base premium.” In addition, various parameters, uses of the parameters, and/or preferences associated with the parameters may be grouped together into monitoring packages. Each of these packages may be assigned a percentage discount or surcharge. If multiple packages are selected, the associated discounts and/or surcharges may be combined together, but any duplicate discounts or surcharges for data items included in more than one selected package may be adjusted as appropriate.

In some embodiments, a premium may be affected by the mere selection of a parameter and/or the mere selection of a monitoring rule or preference. For example, the selection of each parameter and/or preference may result in a fixed, per data item discount or surcharge that is combined with others. In other embodiments, different parameters and/or preferences may result in different discounts or surcharges by, for example, assigning different weights to different parameters and/or preferences. In those embodiments, the weighting of the parameters and/or preferences may be based on how predictive of risk the parameters and/or preferences have been shown to be through analytical techniques. The client may, in some embodiments, have the ability to designate the relative weighting of the data items. In other embodiments, a premium may depend on combinations of the selected parameters, selected preferences, and/or monitored values associated with those selected parameters and/or preferences. In such embodiments, different parameters and/or preferences may be given different weights, which then may vary further depending on the monitored values associated with those parameters/preferences.

The relationship between a premium and a monitored value may be based on various functions, e.g., linear, stepped, or a smoothly changing slope. Using speed in excess of a speed limit as an example, one brief period of time over a speed limit may have no effect on the premium, two (2) five-minute (5-min) periods may result in a one percent (1%) surcharge, and four (4) five-minute (5-min) periods may result in a three percent (3%) surcharge. In another embodiment, once ten (10) five-minute (5-min) periods in excess of the speed limit are detected, this parameter may have no further effect on the premium, regardless of how many more times a client drives in excess of the speed limit. In other cases, each five-minute (5-min) period in excess of the speed limit may result in a constant surcharge that continually increases for every detected period. In addition, out of tolerance measurements for certain combinations of parameters may have an enhanced effect on discounts and/or surcharges. For example, a surcharge for speeding may be increased beyond its normal value if it is also detected that the seat belt is not in use and/or the vehicle is out of maintenance (e.g., the vehicle's tire pressure is low). In another example, speeding in certain areas (e.g., large rural highways with few intersections or exits) may result in a lesser surcharge than speeding in other areas (e.g., a crowded urban areas with many intersections).

Exemplary monitoring parameters and exemplary uses of those parameters in calculating an insurance premium or a discount and/or surcharge to a premium include, but are not limited to, those listed below. Other parameters may also be utilized. In addition, parameters indicated as providing a discount may result in a surcharge in certain circumstances.

Mileage: a discount applied to a premium determined by a defined relationship with the total miles traveled in a specific period of time, or the type of miles driven, such as fraction of miles driven on highways or rural roads.

Speeding: a discount applied to a premium determined by a defined relationship with the number of events in which the vehicle's speed exceeds a predetermined threshold, based on at least one of absolute speed of the vehicle, speed of the vehicle in relation to the posted speed limit on a traveled roadway, and the speed of the vehicle in relation to the speed of other vehicles on the traveled roadway in a specific period of time.

Observing traffic control: a discount applied to a premium if an emergency management call system is activated, or active use of a traffic congestion monitor for areas, such as urban road networks, freeway networks, and ability to change traffic routes using a traffic guidance/avoidance system.

Hard Braking: a discount applied to a premium determined by a defined relationship with the number of events where the vehicle's rate of deceleration (braking) exceeds a predetermined threshold in a specific period of time, or where the vehicle's rate of deceleration exceeds a variable threshold in a specific period of time based on the vehicle's speed at the start of deceleration.

Hard Cornering: a discount applied to a premium determined by a defined relationship with the number of events where the vehicle's speed during specific driving maneuvers exceeds a predetermined threshold in a specific period of time, where the lateral acceleration exceeds a predetermined threshold in a specific period of time, or where the lateral acceleration exceeds a predetermined variable threshold in a specific period of time based on the type of cornering and/or location, such as an expressway ramp or an intersection.

Hard Acceleration: a discount applied to a premium determined by a defined relationship with the number of events where the vehicle's rate of acceleration exceeds a predetermined threshold in a specific period of time, or where the vehicle's rate of acceleration exceeds a variable threshold in a specific period of time based on the vehicle's speed at the start of acceleration.

Swerving/Erratic: a discount applied to a premium determined by a defined relationship with the number of events where the lateral movement of a vehicle while traveling in a traffic control lane exceeds a predetermined threshold in a specific period of time, or where the lateral movement of a vehicle equipped with lane guidance systems exceeds a predetermined threshold in a specific period of time given lane guidance system readout information.

Seat Belt usage: a discount applied to a premium determined by a defined relationship with the number of events where the operator's and passenger's seat belts are not utilized during vehicle travel exceeds a predetermined threshold in a specific period of time.

Turn signal usage: a discount applied to a premium determined by a defined relationship with the number of events where a vehicle's turn signal is not used prior to the initiation of specific driving maneuvers requiring their use in a specific period of time.

Tailgating: a discount applied to a premium determined by a defined relationship with the number of events where the distance between the vehicle and a vehicle directly front of it is less than a specified threshold in a specific period of time, or where the distance between the vehicle and a vehicle directly in front of it is less than a variable threshold based on the following vehicle's speed in a specific period of time.

Green Driving: a discount applied to a premium determined by a defined relationship where the vehicle's carbon emissions are less than a defined threshold in a specific period of time, where the vehicle's speed and acceleration patterns given the road type indicate efficient driving, or where a green driving system (e.g., OEM, mobile application, etc.) indicates green driving behavior above a defined threshold over a specific period of time.

Distraction: a discount applied to a premium determined by a defined relationship between the number and duration of events where the operator is distracted in the course of operating a motor vehicle as indicated through in-cab video (e.g., “eyes up” technology) or other means (e.g., monitoring operator's use of a cellular device) is less than a specific threshold in a specific period of time, or where the operator utilizes one or more systems to minimize distraction while driving, such as cell phone signal blocking applications.

Near collision: a discount applied to a premium determined by a defined relationship which the number and duration of events where the a near-collision noted in a video system or other means, but not otherwise indicated in other telematics systems is less than a specific threshold in a specific period of time.

Naturalistic behavior: observance of behavior of the driver or other key individuals in their own setting that may be indicative of risk.

Total driving time: a discount applied to a premium determined by a defined relationship with the total seconds a vehicle is in motion in a specific period of time. Time a vehicle is in motion may be determined by measurements when the vehicle is in motion (e.g., using phone, GPS, etc.) and/or when the vehicle at rest (e.g., measuring the amount of time the engine is turned off).

Time of day: a discount applied to a premium determined by a defined relationship where the total seconds a vehicle is in motion during specific periods of time and/or during specific days of the week exceeds a predetermined threshold. This may be particularly applicable, for example, for hired vehicles (e.g., independent contractors, owner operator, etc.).

Location: a discount applied based on where a vehicle for the majority of the time, such as: Work parking: if your vehicle is located at your place of employment or parking garage associated with your employment; Home parking: if your vehicle is located at your place of residence (garage, carport, or open air); Location-driven: depending on where your vehicle is driven (e.g., rural roads, urban or highway), where the vehicle is driven most often (e.g., average zip code of vehicle location based on total seconds the vehicle is in motion), or a combination of prevalent locations where the vehicle is parked and/or is driven.

Weather: a discount applied based on time spent or performance while driving in certain weather conditions. In some embodiments, external weather conditions such as temperature, humidity, pressure, etc. may be measured. Alternatively and/or in addition, third party data (e.g., NOAA data) may be used to determine weather conditions.

Behavioral: an aspect of the driver's overall behavior that may be indicative of losses when considered alone or in combination with other measured behaviors.

Drug/Alcohol usage: a discount applied based on measurement of drug or alcohol level (e.g., breathalyzer).

Fatigue: a discount applied based on the driver not being fatigued while driving, as determined by fatigue sensors, or where the vehicle is driven less than a determined threshold during particular times of day or days of week where prevalence of fatigue is higher than a predetermined threshold.

Maintenance: a discount applied based on the maintenance level of the vehicle (e.g., engine light on, car status report based on parameters available from vehicle's OBD port, tire pressure monitor, engine temperature monitor, airbag monitor, seatbelt monitor, window position monitor, door monitor, visibility monitor, in-cab or external video feed, the vehicle's electrical, mechanical, and emissions systems, etc.

Application usage: a discount applied to a premium determined by a defined relationship with the usage of specified software applications (e.g., smart phone apps, automatic car start, or other features/tools).

As described above, various data items and uses of the data items may be grouped into packages. Packages may be, for example, time-based, location-based, time- and location-based, safety-based, high-risk, green, teen driving, carpool/commuter, sleeping, DUI, distracted driver, and various combinations thereof. Some examples are provided below, that may be based on, for example, data items described above and additional data items described below.

Safety package: based on the type of safety devices (e.g., in the event of a collision in which the airbags are deployed, or whether airbags deploy and an automatic crash response is sent to assist emergency response efforts), or where an operator utilizes driver feedback or other systems to modify driving behavior to increase safe driving characteristics, whether real-time or through post-driving reports and feedback.

High risk package: based on a determination if high risk driving has or could occur. This may include time spent driving during particular times of day or days of week, time spent driving during predetermined weather conditions, time spent driving during particular traffic congestion conditions, or a combination of driving behavior factors that are indicative of risky driving behavior.

Green Package: based on a determination of the types of miles driven, CO₂ emissions, O₂ sensor readings, vehicle's mileage per gallon, greenhouse gas emissions, materials vehicle is constructed of, utilization of green driving systems, such as real-time feedback to driver to facilitate green driving behavior, or amount of time vehicle is idling.

Teen Driving Package: based on a determination of the types of educational courses completed, types of telematics devices installed, types of distraction-free technologies employed, types of miles driven, and time of day the vehicle is driven during the teen operations, or based on usage of vehicle monitoring systems such as geo-fencing or time-of-day alerts via text message, e-mail, or other immediate communication to owner of vehicle.

Carpool/Commuter Package: based on a determination if the vehicle operator, during normal business hours (day or evening), is considered to be a commuter or uses an official carpooling service.

Time Windows Package: monitoring and/or utilization of certain and/or various parameters limited to and/or excluded from (and/or otherwise based on) certain times, times of year, seasons, and/or days of the week (e.g., day only, night only, off-peak only, weekend only).

Risk Zones Package: monitoring and/or utilization of certain and/or various parameters limited to or excluded from (and/or otherwise based on) one or more road segments, intersections, traffic and/or parking structures or areas, districts, areas, and/or other location-based zones or data points.

Busyness Package: monitoring and/or utilization of certain and/or various parameters limited to or excluded from (and/or otherwise based on) one or more indicators of busyness (e.g., as described in co-pending U.S. patent application Ser. No. 12/978,535 filed on Dec. 24, 2010 and titled “RISK ASSESSMENT AND CONTROL, INSURANCE PREMIUM DETERMINATIONS, AND OTHER APPLICATIONS USING BUSYNESS”, the “busyness” concepts and descriptions of which are hereby incorporated by reference herein).

Sleeping Package: based on a determination if the vehicle operator, during hours the vehicle is in motion (day or evening), is sleeping, or drowsy.

DUI Package: based on determination if a vehicle operator is deemed safe to operate a vehicle without the impairment of alcohol or legal/illegal pharmaceuticals.

Distracted Driving Package: based on a determination of the types educational courses completed, types of telematics devices installed, types of distraction-free technologies employed, types of miles driven, types of in-vehicle driver feedback employed (e.g., cell phone usage, in-cab video, etc.), number of occupants in the vehicle, and/or time of day the vehicle is driven during the vehicle's operations.

According to some embodiments, based on the monitoring parameters and/or preferences selected, and/or the values measured for the respective monitoring parameters, the insurance company may underwrite a given client into a respective product, program, and/or company. A product, sometimes referred to as a program or package (the terms are used interchangeably herein), may generally comprise a marketing concept that represents an offering to a client. In various embodiments, the product (or program or package) may be a collection of features, which includes a particular pricing plan, particular benefits, limitations, qualifications, etc. The product (or program or package) may have its own unique insurance contract and/or may use the same insurance contract as other products. Clients who qualify may, for example, be placed into an “experienced driver product” or a “safe teens product,” etc. A product may be available through one or many companies, but it should generally be associated with at least one company to be a viable product, because the insurance contract is written under the auspices of that company. Underwriting into a company refers to the insurance company using data to determine which one, among several different subsidiary companies doing business in a state, to place the client into. In some cases, based on the monitoring parameters and/or preferences, it may be necessary to underwrite into a different product within the same company. In other cases, it may be necessary to place the client with a new company altogether.

In an exemplary interaction between a client and an insurance company, the client may learn about the insurance telematics program through advertisements (e.g., television, internet, radio, etc.), solicitation from an agent, and/or solicitation through mail, for example. The client may utilize an on-line quoting and issuance system to determine possible quotes and input demographic information. The insurance system may configure and display potential client discounts or surcharges based on, e.g., packages or various selected data items and/or preferences. The client may, for example, select itemized parameters for monitoring (i.e., specific desired data items), preferences defining when and/or how such parameters should be monitored and/or utilized, one or more packages of parameters, a combination of itemized parameters and packages, or no monitoring at all. The client may make these various selections based on, e.g., individual drivers, various vehicles, various fleets, groups of drivers, driver-vehicle combinations, etc. The client may then finalize the selections and the insurance company may quote and/or issue a policy.

One or more telematics devices (such as the telematics devices 302 of FIG. 3 herein) may be configured based on, for example, the client selections. The client may view the possible discounts and/or surcharges and selections, and adjust the selections during the insurance policy term. Such adjustments may be carried out, for example, by using a web portal, speaking or communicating with an agent, receiving an automatically generated report or bill, and/or receiving a vendor report. When a client, for example, changes the monitored selections, the system may reconfigure its settings and reconfigure the telematics device as described herein. In some embodiments, the client may affect his insurance premium discount or surcharge by, for example, changing driving behavior (e.g., via implementation of a corrective action plan for a business) or opting out of the program.

According to some embodiments, a telemetric monitoring device may be operable to monitor a plurality of telemetric parameters. The device may comprise an electronic processing device, a wireless communication device in communication with the electronic processing device, and/or a remotely programmable memory in communication with the electronic processing device and the wireless communication device.

In some embodiments, the programmable memory stores instructions that when executed by the electronic processing device may result in execution of various procedures and/or methods. In FIG. 5, for example, a method 500 according to some embodiments may comprise determining (e.g., based on an instruction from a remote device) a subset of a plurality of telemetric parameters that are to be monitored, at 502. The instructions, when executed, may further result in monitoring the determined subset of the plurality of telemetric parameters, storing, by the remotely programmable memory, information descriptive of the monitored subset of the plurality of telemetric parameters, and/or transmitting, by the wireless communication device and to a remote server device, an indication of the information descriptive of the monitored subset of the plurality of telemetric parameters. In some embodiments, the method 500 may comprise causing, based on the received indication of the definition of the subset of the set of parameters, the monitoring device to report only the subset of the set of parameters, at 504. In such a manner, for example, a telematics device may be customized based on client preferences. In some embodiments, client selected and/or defined constraints, rules, and/or triggers may also or alternatively be set via remote programming of the telematics device. Various time-windows, geographic constraints, and/or environmental triggers may be set, for example, that cause the telematics device to adjust operations (e.g., on/off, monitor/don't monitor) based on the client-defined preferences.

In some embodiments, the stored instructions, when executed by the electronic processing device, may result in receiving (e.g., via the wireless communication device) the instructions from a remote device. In a further embodiment, the remote device may comprise a smart phone operated by a client. In yet another embodiment, the remote device may comprise a key fob storing information identifying a client. In a still further embodiment, the remote device and the remote server device may be the same.

In some embodiments, the telemetric monitoring device may comprise a sensor device coupled to a vehicle and the subset of the plurality of telemetric parameters may comprise one or more of: (i) a vehicle speed parameter; (ii) a vehicle door status parameter; (iii) a vehicle window status parameter; (iv) a vehicle seatbelt status parameter; (v) a vehicle acceleration parameter; (vi) a vehicle braking parameter; (vii) a vehicle airbag status parameter; (viii) a vehicle tire pressure parameter; (ix) a vehicle usage parameter; (x) a vehicle turn signal status parameter; (xi) a vehicle engine parameter; (xii) a vehicle location parameter, (xiii) a monitoring time-window, (xiv) a monitoring geographic and/or location rule, and/or (xv) an environmental monitoring trigger.

In other embodiments, the telemetric monitoring device may comprise a sensor device coupled to sense a driver of a vehicle and the subset of the plurality of telemetric parameters may comprise one or more of: (i) a driver distraction parameter; (ii) a driver fatigue parameter; and (iii) a driver substance abuse parameter.

FIG. 6, FIG. 7, FIG. 8, FIG. 9, FIG. 10A, FIG. 10B, FIG. 11A, FIG. 11B, and FIG. 12 depict exemplary user interfaces 600, 700, 800, 900, 1000, 1100, 1200 that may presented to and used by prospective clients, current clients, and/or insurance agents and/or insurance company employees, e.g., to develop premium estimates/quotes, select data items, update selected data items, select and/or define monitoring preferences, update selected and/or defined monitoring preferences, and/or update the identification of participating individuals, entities, and/or vehicles. The exemplary user interfaces may be presented on a browser, such as a web browser or a Wireless Application Protocol (WAP) browser on a client's business computer or mobile device (e.g., phone, PDA) over a connection to a network (e.g., the network 306 of FIG. 3), for example, or on a computer that is part of an insurance company computer system (e.g., the insurance company computer system 310 of FIG. 3). Other arrangements may also or alternatively be utilized. In some embodiments, instead of or in addition to browser windows, clients may configure their policies (e.g., update their selected parameters and/or preferences) utilizing messaging, such as text messaging over SMS. In some embodiments, the user interfaces 600, 700, 800, 900, 1000, 1100, 1200 may be provided by an application running on a client's mobile device(s) and/or may be integrated into the client's vehicle(s), such as being incorporated into the vehicle's trip computer and/or onboard navigational system (OEM and/or after-market).

In various embodiments, the updates discussed herein may result in real time updates to the system settings for monitoring parameters and/or preferences. Thus, clients may possess a high degree of control over the selection of data items that are monitored, recorded, transmitted, and/or utilized, and/or how and/or when such parameters are monitored, recorded, transmitted, and/or utilized, as a basis for insurance premium calculation. For example, if a client updates a selection of parameters to be monitored for a specific vehicle (and/or preferences governing such monitoring), the system may program a telematics device monitoring that vehicle in real time. In some embodiments, the client may receive confirmation not only of his selected data items and/or preferences, but also that a telematics device has been programmed in accordance with those selected data items. For example, if the client sends an SMS text message indicating that his location should no longer be monitored (e.g., a geographic and/or location “stop monitoring” trigger—one-time or for recurrence), the system may program a telematics device associated with his vehicle to stop monitoring location and send the client an SMS or other text message indicating that the telematics device has been reprogrammed per his instructions. In addition, different individuals (e.g., fleet drivers) who share a vehicle may login to a telematics device of that vehicle when, for example, they enter the vehicle. Moreover, the individual's login may cause the system to reprogram the telematics device (and/or, e.g., the monitoring service computer or insurance company computer's data item filtering system) to conform to that individual's settings in real time. In addition, the individual may be notified, e.g., by SMS message, that the reprogramming has been performed.

FIG. 7 illustrates an itemized parameter selection screen interface 700 that may be utilized, for example, by a client through a web portal, smart-phone application, in-vehicle device, IVRU, or by an insurance agent on the phone with a client. As shown, the client may select (e.g., for one or more specific vehicles 702 (and/or drivers or combinations thereof)) one or more parameters to be monitored 710 at the left of the screen (speed 710-1, acceleration 710-2, location and mileage 710-3, and/or safety belt 710-4). Within each of these example parameters 710, there are sub-items 712 shown to the right of the parameters (e.g., speed monitoring 712-1a, speed monitoring with in-cab feedback 712-1b, low-precision acceleration monitoring 712-2a, high-precision acceleration monitoring 712-2b, total miles driven 712-3a, miles driven in territory 712-3b, miles driven and location monitoring 712-3c, safety belt monitoring 712-4a, and/or safety belt monitoring with in-cab feedback 712-4b). For example, if speed monitoring 710-1 is selected, the client may select in-cab feedback 712-1b if desired. In some embodiments, such as if, for example, the data item 710 is not selected, then the sub-items 712 may not be selected, and are displayed in a lighter shade of text (e.g., as shown by the safety belt monitoring sub-items 712-4). Other sets of parameters and sub-items may also or alternatively be utilized.

In the illustrated embodiment, a first set of discount/surcharge columns 714 show the maximum possible percentage ranges of discount/surcharge that selection of data items 710 may result in (for each of liability and physical damage). For example, the indicated speed monitoring selection 710-1, 712-1a could result in between a negative five percent (−5%) and positive three percent (+3%) change in a liability component of a premium and a negative seven percent (−7%) to positive eight percent (+8%) change in the physical damage component of the premium. The second set of discount/surcharge columns 716 show the predicted discount range(s) based on, for example, drivers with similar profiles to the current client. For example, the indicated speed monitoring selection 710-1, 712-1a may be predicted to result in between a negative three percent (−3%) and positive three percent (+3%) change in the liability component of the premium and a negative five percent (−5%) to positive five percent (+5%) change in the physical damage component of the premium. The discounts of each column 714, 716 are totaled in the “Total” row 718 at the bottom of the columns 714, 716.

In some embodiments, the maximum possible premium range 720, the predicted premium range 722, and the estimated premium 724 in dollars are shown along the bottom of the screen. In this example, the client's maximum possible premium range 720 is between four hundred and forty-eight dollars ($448) and eight hundred and forty-eight dollars ($848); the predicted premium range 622 is between five hundred and forty-eight dollars ($548) and seven hundred and forty-eight dollars ($748); and the estimated premium 724 is six hundred and forty-eight dollars ($648).

If the client would like to see the effect that allowing the monitoring of various parameters 710 or combinations of parameters 710 has on the insurance premium (e.g., the estimated premium 724), the client may enter one or more parameters 710 and/or sub-items 712 and click on “APPLY” to populate the chart. Once the client is satisfied with the selections, the settings may be entered by clicking “OK.” In some embodiments, buttons or other navigational aids or tools may be provided to allow the client to switch views and/or go to other data screens, such as the “Go to Grouped Parameter View” button 730 (selection of which, e.g., may cause the interface 800 of FIG. 8 to be provided), the “Go to Preferences View” button 732 (selection of which, e.g., may cause the interface 900 of FIG. 9 to be provided), the “Go to Itemized Vehicle View” button 734 (selection of which, e.g., may cause the interface 1000 of FIG. 10A and/or FIG. 10B to be provided), and/or the “Go to Package View” button 736 (selection of which, e.g., may cause the interface 1100 of FIG. 11A and/or FIG. 11B to be provided).

FIG. 8 illustrates an embodiment of a grouped parameter view selection screen interface 800 that may be utilized in a similar manner to the user interface 700 shown in FIG. 7. In the illustrated example, the client has selected three (3) parameter groups 810 (e.g., and indications of such selection(s) have been received): a time-based group 810-1, a safety group 810-2, and a location-based group 810-3. In some embodiments, multiple option selections 812 may be made within each set of parameter groups 810 (e.g., total driving time option 812-1a, time window option 812-1b, work hours option 812-1c, crash notification option 812-2a, automatic GPS location option 812-2b, profile deviation option 812-2c, driving rules option 812-2d, work parking option 812-3a, deliveries option 812-3b, geo-“fencing” option 812-3c, and/or risk zones option 812-3d). For example, it may be possible to select both “work parking” option 812-3a and the “deliveries” option 812-3b. Additional or alternative options 812 (not shown in FIG. 8) may include, e.g., constant location monitoring or parked location monitoring. Other arrangements of parameters 810 and/or options 812 may also or alternatively be utilized. In some embodiments, buttons or other navigational aids or tools may be provided to allow the client to switch views and/or go to other data screens, such as the “Go to Preferences View” button 832 (selection of which, e.g., may cause the interface 900 of FIG. 9 to be provided), the “Go to Itemized Vehicle View” button 834 (selection of which, e.g., may cause the interface 1000 of FIG. 10A and/or FIG. 10B to be provided), the “Go to Package View” button 836 (selection of which, e.g., may cause the interface 1100 of FIG. 11A and/or FIG. 11B to be provided), and/or the “Go to Itemized Parameter View” button 838 (selection of which, e.g., may cause the interface 700 of FIG. 7 to be provided).

Referring now to FIG. 9, an example preferences view interface 900 according to some embodiments is shown. In some embodiments, the interface 900 may be configured to permit a client (and/or other user) to select and/or define (e.g., for one or more specific vehicles 902 (and/or drivers or combinations thereof)) various preferences 910 relating to telematic monitoring. As shown in the example interface 900, such preferences 910 may comprise (but are not limited to), initial data capture window preferences 910-1, risk zones/geo-“fencing” preferences 910-2 (and/or busyness preferences), monitoring preferences 910-3, data capture frequency preferences 910-4, data capture windows preferences 910-5, and/or forgiveness preferences 910-6. In some embodiments, the interface 900 may also or alternatively be configured to allow a client to manage a matrix of preferences 910-7. For a list of selected parameters 910-7a, for example, one or more rules 910-7b (e.g., other preferences) may be activated, deactivated, associated, disassociated, modified, and/or otherwise defined and/or managed. As shown in the example interface 900, for example, a rule 910-7b regarding “time window(s)” may be activated for various selected parameters 910-7a such as “acceleration monitoring” and/or “location monitoring”. Such activation and/or relation may, in some embodiments, indicate that acceleration monitoring and location monitoring are to be conducted in accordance with one or more “time window(s)” rules 910-7b. Such rules 910-7b may be defined by the client (e.g., by clicking on and/or otherwise selecting the “time window(s)” text and/or associated selection boxes in the interface 900) and may, for example, define time conditions during which acceleration and/or location should, or should not, be monitored and/or analyzed. In some embodiments, the rule 910-7b may comprise “driving rules” which may, for example, compare local, state, federal, Department of Transportation (DOT), and/or other or customized laws, rules, ordinances, and/or restrictions to associated selected parameters 910-7a, such as to the “speed monitoring” as shown in the example interface 900. In such a manner, for example, monitored speed may be compared to selected and/or defined regulations or restrictions to determine whether a positive or negative driving event has occurred. In some embodiments, “risk zones” rules 910-7b may define geographic areas, road segments, etc., that are associated with various levels of risk (and/or busyness) in which or outside of which, for example, location monitoring will be conducted. Similarly, geo-“fencing” rules 910-7b may comprise rules defining geographic boundaries within which and/or outside of location monitoring is to take place, is not to take place, and/or is to take place in a certain manner (e.g., within or outside of certain zones, such as “privacy” or “personal” zones, location monitoring may be disabled or may still occur, but with a reduced precision or resolution—e.g., instead of utilizing GPS coordinates, postal codes may be monitored).

According to some embodiments, any or all of the various preferences 910 may be associated with an insurance modifier 914. Selections of preferences 910 (and/or combinations of preferences 910) that are less risky and/or otherwise more favorable to an insurer, for example, may result in discounts, lower premiums and/or deductibles, and/or rewards, while more risky (or potentially more risky or involving less oversight) selections may result in surcharges, penalties, and/or higher premiums and/or deductibles. As shown in the example interface 900, for example, the initial data capture window preferences 910-1 being set at “90 days” may result in a ten percent (10%) discount 914-1, the risk zones/geo-“fencing” preferences 910-2 being turned “off” may result in a twenty percent (20%) surcharge 914-2, the monitoring preferences 910-3 being set to enable alerts (e.g., via SMS) may result in a five percent (5%) discount 914-3, the data capture frequency preferences 910-4 being set to five (5) days per month may result in a five percent (5%) discount 914-4, the data capture preferences 910-5 being set to “random” may result in a ten percent (10%) discount 914-5, and/or the forgiveness preferences 910-6 being set to “Gold” level with status alerts enabled may result in a fifteen percent (15%) surcharge 914-6. In some embodiments, the selections made in the matrix of preferences 910-7 may result in a two percent (2%) total discount 914-7, as shown in the example. According to some embodiments, a total modifier 920 may be displayed, showing the total positive or negative (or neutral) effect of application of any or all of the individual insurance modifiers 914 (in the example of FIG. 8, a three percent (3%) surcharge).

According to some embodiments, the interface 900 may comprise a datum selector 940 that may, for example, allow a client to select from a plurality of available variables for which the interface 900 may be provided. In the example of FIG. 9, the client may utilize the datum selector 940 to choose between providing and/or showing “premium”, “deductible”, “rewards”, and/or other (“ . . . ”) information. In such a manner, for example, the total modifier 920 may be viewed in context as applied to various variables (e.g., a datum), such as expected and/or current insurance premiums, expected and/or current insurance deductibles, and/or expected and/or current rewards (e.g., credits, airlines miles, and/or other reward points or benefits). In some embodiments, a balance/bank 942 may be provided. The balance/bank 942 may, for example, provide a current and/or expected value associated with any particular variable selected via the datum selector 940. As shown in FIG. 9, for example, the balance/bank may provide the current and/or expected (e.g., quoted) insurance premium level and/or magnitude (with or without the total modifier 920 included; e.g., gross or net).

In some embodiments, buttons or other navigational aids or tools may be provided to allow the client to switch views and/or go to other data screens, such as the “Go to Grouped Parameter View” button 930 (selection of which, e.g., may cause the interface 800 of FIG. 8 to be provided), the “Go to Itemized Vehicle View” button 934 (selection of which, e.g., may cause the interface 1000 of FIG. 10A and/or FIG. 10B to be provided), the “Go to Package View” button 936 (selection of which, e.g., may cause the interface 1100 of FIG. 11A and/or FIG. 11B to be provided), and/or the “Go to Itemized Parameter View” button 938 (selection of which, e.g., may cause the interface 700 of FIG. 7 to be provided).

FIG. 10A illustrate an exemplary itemized vehicle user interface 1000 having a scheduled listing of vehicles 1002, along with the itemized parameters 1010 selected for each listed vehicle 1002. The listed vehicles 1002 may be identified by number, type, year, make, model, VIN, etc. In one embodiment, the user interface 1000 shown in FIG. 10A (and/or FIG. 10B) may display the parameters 1010 that were/are selected for each listed vehicle 1002 on any or all of the other interfaces 600, 700, 800, 900, 1100, 1200. In another embodiment, a user may select parameters 1010 on any or all of the other user interfaces 600, 700, 800, 900, 1100, 1200. In addition to the itemized parameters 1010, an estimated premium 1024 for each listed vehicle 1002 is shown in the right column. A user may add additional vehicles by clicking on (or otherwise selecting) the “ADD ANOTHER VEHICLE” button 1004. FIG. 10B illustrates the exemplary user interface 1000 having a composite listing of vehicle classes (or types) 1006, along with the itemized parameters 1010 selected for each class of vehicles 1006. As shown, selections of parameters 1010 and/or selection of vehicle class quantities 1008 may be made on the interface 1000 for the different classes of vehicles 1006. For example, in the illustrated embodiment, a client has indicated they have three (3) light duty trucks and they would like speed, acceleration, location and mileage, and safety belt monitoring for that class 1006. When, for example, a change is made to the monitoring of a class 1006, the change affects each listed vehicle 1002 in that class 1006. The estimated premium 1024 is listed on the right per listed vehicle 1002 and/or per class of vehicles 1006. In some embodiments, buttons or other navigational aids or tools may be provided to allow the client to switch views and/or go to other data screens, such as the “Go to Grouped Parameter View” button 1030 (selection of which, e.g., may cause the interface 800 of FIG. 8 to be provided), the “Go to Preferences View” button 1032 (selection of which, e.g., may cause the interface 900 of FIG. 9 to be provided), the “Go to Package View” button 1036 (selection of which, e.g., may cause the interface 1100 of FIG. 11A and/or FIG. 11B to be provided), and/or the “Go to Itemized Parameter View” button 1038 (selection of which, e.g., may cause the interface 700 of FIG. 7 to be provided).

FIG. 11A illustrates an exemplary package view user interface 1100 having a scheduled listing of vehicles 1102, along with a plurality of parameter packages 1110 selected for each listed vehicle 1102. As with the embodiment shown in the interface 1000 of FIG. 10A and/or FIG. 10B, the user interface 1100 of FIG. 11A (and/or FIG. 11B) may display the parameter package 1110 selections made for each listed vehicle 1102 in the other interfaces 600, 700, 800, 900, 1000, 1200, in some embodiments, may allow a user to select or update packages of parameters 1110. In addition to the parameter packages 1110, an estimated premium 1124 for each listed vehicle 1102 may be shown in the right column. A user may add additional vehicles by clicking on an “ADD ANOTHER VEHICLE” button 1104. In one embodiment, the parameter packages 1110 that are displayed may be based on results of a survey and/or questionnaire regarding a vehicle fleet. FIG. 11B illustrates the exemplary user interface 1100 having a composite listing of vehicle classes (or types) 1106, along with the parameter packages 1110 selected for each class of vehicles 1106. As shown, selections of parameters 1110 and/or selection of vehicle class quantities 1108 may be made on the interface 1100 for the different classes of vehicles 1106. For example, in the illustrated embodiment, a client has indicated they have three (3) light duty trucks and they would like “monitoring package 1” activated for that class 1106. When, for example, a change is made to the monitoring of a class 1106, the change affects each listed vehicle 1102 in that class 1106. The estimated premium 1124 is listed on the right per listed vehicle 1102 and/or per class of vehicles 1106. In some embodiments, buttons or other navigational aids or tools may be provided to allow the client to switch views and/or go to other data screens, such as the “Go to Grouped Parameter View” button 1130 (selection of which, e.g., may cause the interface 800 of FIG. 8 to be provided), the “Go to Preferences View” button 1132 (selection of which, e.g., may cause the interface 900 of FIG. 9 to be provided), the “Go to Itemized Vehicle View” button 1134 (selection of which, e.g., may cause the interface 1000 of FIG. 10A and/or FIG. 10B to be provided), and/or the “Go to Itemized Parameter View” button 1138 (selection of which, e.g., may cause the interface 700 of FIG. 7 to be provided).

FIG. 12 illustrates an exemplary user interface 1200 showing various surcharge and discount events. In some embodiments, data descriptive of the events includes the location where the events occurred, e.g., on a map interface as shown. The interface 1200 of FIG. 12 may be displayed, e.g., on the computer screen of a client or agent accessing the client's account. Box 1210 identifies select surcharge events and box 1220 identifies select discount events. Box 1230 includes box 1231, which identifies on a map the location where various events occurred, as described in the text of box 1232. Various additional data may also be displayed in FIG. 12. For example, the events in window 1232 may be color coded to indicate the parameters the client has selected for monitoring.

In an embodiment where a client allows all data items to be monitored, but only some data items to be utilized, for example, the data items that are utilized may be displayed in green and those not used may be displayed in red. In addition, in some embodiments, the client may click on the various displayed events using a pointer controlled by a user input device, and the system may calculate and display estimates of what the client's insurance cost would have been had the client allowed (or not allowed) data items related to the clicked on events to be used in calculating his premium.

Any or all of the interfaces 600, 700, 800, 900, 1000, 1100, 1200 may be altered in various ways. For example, instead of providing fields indicating the maximum possible ranges and predicted ranges of the premium, a pictorial representation of this information may be displayed (e.g., a bar with heavier shading near the estimated value near the center of the bar and lighter at the ends of the bar, representing the outer limits of the premium's likely value).

In some embodiments, the monitored data items may be utilized to reconstruct events, such as automobile accidents. The information from the reconstruction may be utilized, e.g., to affect the payment to third parties and/or subrogation of a claim. For example, the speed of a vehicle colliding with an insured vehicle may be determined based on, e.g., the mass of the two vehicles combined with one or more of the monitored data items (e.g., speed, direction, acceleration, etc.). In another example, the g-force an accident victim was exposed to may be determined based on similar information, and potential fraud may be detected based on medical information indicating that certain types of injuries (e.g., soft tissue damage) are extremely unlikely to occur in certain conditions (e.g., below a certain g-force threshold). Similarly, where geo-“fencing” and/or other location tracking is enabled, various location-based fraud events may be detected based on monitored parameters. When borders outside of agreed-upon travel areas and/or borders into risk zones are crossed, for example, fraud and/or surcharge events may be triggered and/or determined. In some embodiments, location monitoring may be utilized to infer “garaging” locations that, in fraudulent situations, may be indicated (e.g., on policy and/or application papers) in locations that are less risky and/or cheaper to insure than in the location where a vehicle is actually determined to be kept.

The systems, media, and methods described herein may be used for various types of insurance including, for example, automobile, boat, property, worker's compensation, liability, etc. and various combinations of the same. For example, a property owner could agree to have utility usage monitored in order to determine whether the property was vacant, but not for example, monitoring other aspects of home use. A worker's compensation insurance client (e.g., the insured, the insured representative, a company with insured employees, etc.) might choose to allow payroll monitoring, but not, for example, video monitoring of the worksite.

In some embodiments, data items monitored in relation to one type of activity may be used in determining an insurance premium for various types of policies. For example, a premium for workers compensation insurance may depend on monitoring data items of a worker's driving. A client may select the parameters to be monitored for respective policies (or, e.g., for his employees policies). For example, a client may decide to allow her driving speed to be used in determining her automobile insurance premium, but not for her workers compensation premium. In another example, a client's monitored data items may be used to generate a score, e.g., representative of the client's risk level. This level may be indicative of the client's risk across various areas and may be used as a factor in determining a premium for various types of policies (e.g., home owner's, workers compensation, etc.). Selections of monitored parameters for given policies may also be made at the fleet level. For example, the premium for workers compensation insurance for drivers associated with a fleet may depend on the monitored data items associated with the fleet.

As described herein, an insurance company may allow a client to select various parameters and/or preferences. In some embodiments, parameters and/or preferences may be set, suggested, and/or required by the insurance company (or a third-party). The parameters and/or preferences available for selection and/or required for monitoring may depend on various considerations, including, e.g., one or more of: a type of risk (e.g., based on whether the client is a wholesaler, a contractor, and manufacturer, etc); a product or collection of products (e.g., which insurance product or line of products is at issue); a risk assessment and/or classification of the client (e.g., non-standard/risky clients may be required to have more parameters monitored than a standard/lower risk client—such as, e.g., a non-standard client may be required to have video monitoring); history based (e.g., an individual or collective driving history, such as, e.g., requiring all drivers with more than five points to be monitored with an extensive set of data items); loss history (e.g., drivers with more than a certain number of claims or total a total claim over a certain dollar value may be required to have video monitoring); or other types of insurance related considerations.

In some embodiments, an insurance company may review monitored data items and/or preferences associated with a fleet of vehicles to, e.g. determine and/or advise the client (e.g., the fleet manager) whether the monitoring of data items, the preferences governing the monitoring, and/or a safety program is accomplishing a desired effect of the fleet manager and/or insurance company (e.g., lowering the premium and/or risk). Based on these determinations, the insurance company may offer a telematics-based risk management or control program to, e.g., suggest options to the fleet manager for lowering the risk to the fleet or lowering the premium. For example, the data items which reveal high risk behavior (e.g., if there are high number of excessive speeding events) may be identified to the fleet manager, and the fleet manager may choose to direct certain drivers to lower the speeds at which they drive.

Some embodiments may combine various data items to calculate an indication of certain risks. For example, some embodiments may combine data related to hard breaking and swerving to calculate that a near miss has occurred. The calculated indication may be used as indication of risk on which insurance cost may be based. For example, if a driver has one near miss every four (4) years, the insurance company may consider those near misses not to be an indication that the driver is any more likely to get in an accident that a driver with no near misses. However, the insurance company may consider a client that has six (6) near misses in one (1) year to be very likely to get in an accident soon, and decide to adjust that driver's insurance premium upward according to the driver's high number of near misses. In addition, the insurance company may impose higher premiums on any driver that does not elect a near miss package or otherwise select data items and/or monitoring preferences that allow the insurance company to determine the occurrence of near misses.

Various embodiments described herein enable insurance companies to aid clients in both identifying hazards and establishing associated controls to reduce, limit, eliminate, and/or manage those hazards. Any situation that could cause an insured to experience loss is a potential hazard. Not all hazards are covered by insurance. Clients may obtain or purchase risk control or risk management services from an insurance company with or without purchasing other insurance products. The insurance company may help clients to identify hazards through many methods including providing educational materials, classes, etc., performing inspections, recommending organizational structures, policies, operational methods, etc., which help to identify potential hazards. Once clients have identified a potential hazard, the insurance company may further assist by providing educational materials, classes, etc.; recommending organizational structures, policies, operational methods, etc. for reducing, limiting, eliminating or controlling those hazards. [0001] Some situations are more hazardous than others, and require varying kinds of risk management strategies and applications. By choosing to monitor certain items as described herein, both the identification of hazards and the associated controls may be improved. Also, by choosing to monitor certain items, the client may consequently be able to utilize certain of the insurance company's risk control or risk management service or product offerings which depend upon that particular item being monitored (and/or method or type of monitoring), and so would otherwise not be available to that client. In some embodiments, e.g., hazards may be measure by monitoring data items and controlled by adjusting a premium.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners.

In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

It is to be understood that the embodiments described above are not limited in its application to the details of construction and to the arrangements of the components set forth in the above description or illustrated in the drawings. The invention is capable of other embodiments and of being practiced and carried out in various ways. Also, it is to be understood that the phraseology and terminology employed herein are for the purpose of description and should not be regarded as limiting.

For example, the specific sequence of described process may be altered so that certain processes are conducted in parallel or independent with other processes, to the extent that the processes are not dependent upon each other. Thus, the specific order of steps described herein are not to be considered implying a specific sequence of steps to perform the above described process. Other alterations or modifications of the above processes are also contemplated. Accordingly, those skilled in the art will appreciate that the conception upon which this disclosure is based may readily be utilized as a basis for the designing of other structures, methods, and systems for carrying out the several purposes of the present invention. It is important, therefore, that the invention be regarded as including equivalent constructions to those described herein insofar as they do not depart from the scope of the present invention.

The many features and advantages of the invention are apparent from the detailed specification, and thus, it is intended by the appended claims to cover all such features and advantages of the invention which fall within the scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention, as defined by the claims.

1. A method, comprising:
receiving, by a specially-programmed computer device and from a user device, an indication of a request for a fleet insurance product for a fleet of vehicles;
determining, by the specially-programmed computer device, a base premium for the fleet insurance product;
providing, by the specially-programmed computer device and to the user device, a plurality of menu-selectable options, each option representing at least one rule representing at least one of how and when a monitoring parameter relevant to the fleet insurance product is to be monitored;
receiving, by the specially-programmed computer device and from the user device, an indication of a user selection of at least one of the plurality of menu-selectable options;
determining, by the specially-programmed computer device and based on the user selection, an adjusted premium for the fleet insurance product;
providing, by the specially-programmed computer device and to the user device, an indication of the adjusted premium for the fleet insurance product; and
facilitating, by the specially-programmed computer device and based on the adjusted premium, a sale of the fleet insurance product to a client.

2. The method of claim 1, further comprising:
providing, by the specially-programmed computer device and to the user device, an indication of the base premium for the fleet insurance product.

3. The method of claim 1, wherein the adjusted premium comprises at least one of a presently discounted premium and an estimated future discounted premium.

4. The method of claim 1, further comprising:
monitoring, based on the user selection, the parameter relevant to the fleet insurance product.

5. The method of claim 4, wherein the determining of the adjusted premium for the fleet insurance product is further based on the monitoring of the parameter relevant to the fleet insurance product.

6. The method of claim 1, further comprising:
configuring at least one monitoring device to monitor a value for the monitoring parameter in accordance with the at least one rule represented by the user selection.

7. The method of claim 1, further comprising:
receiving, by the specially-programmed computer device and from the user device, an indication of a quantity of vehicles in the fleet that are equipped for monitoring.

8. The method of claim 7, wherein the quantity comprises a percentage of all vehicles in the fleet.

9. The method of claim 8, wherein the quantity comprises a percentage of vehicles of a given class in the fleet.

10. The method of claim 7, wherein the adjusted premium is further based on the quantity of vehicles in the fleet that are equipped for monitoring.

11. The method of claim 1, wherein the user device comprises at least one of an underwriting workstation and a device operated by a member of a business.

12. The method of claim 1, wherein the monitoring parameter comprises an operating characteristic associated with at least one type of vehicle in the fleet of vehicles operated by a business.

13. The method of claim 1, wherein the monitoring parameter comprises an operating characteristic associated with a specific vehicle in the fleet of vehicles operated by a business.

14. The method of claim 1, wherein the monitoring parameter comprises a predefined group of parameters that, together, are descriptive of a characteristic relevant to the fleet insurance product.

15. The method of claim 14, wherein the characteristic relevant to the fleet insurance product comprises one or more of: (i) a safety characteristic; (ii) a high risk characteristic; (iii) a “green” characteristic; (iv) a time window characteristic; (v) a sleeping characteristic; (vi) a distracted driver characteristic; and (viii) a risk zones characteristic.

16. The method of claim 1, wherein determining the adjusted premium for the fleet insurance product, comprises:
determining, for the at least one rule represented by the user selection, a premium adjustment amount; and
calculating the adjusted premium by applying the premium adjustment amount to the base premium.

17. The method of claim 16, wherein the premium adjustment amount comprises at least one of a dollar amount, a percentage, a weight, a discount, and a surcharge.

18. The method of claim 1, wherein receiving an indication of a user selection of at least one of the plurality of menu-selectable options comprises receiving the indication for a class of vehicles in the fleet.

19. The method of claim 18, wherein the class is chosen from private passenger type, light duty trucks, medium duty trucks, heavy duty trucks, and trailers.

20. The method of claim 1, wherein the at least one rule governs: (i) at what time(s) the monitoring parameter is to be monitored; (ii) at what time(s) the monitoring parameter is not to be monitored; (iii) at which vehicle location(s) the monitoring parameter is to be monitored; (iv) at which vehicle location(s) the monitoring parameter is not to be monitored; and (v) what event(s) trigger a monitoring of the monitoring parameter.

21. An apparatus, comprising:
a computerized processing device; and
a memory device in communication with the computerized processing device and storing specially-programmed instructions that when executed by the computerized processing device result in:
receiving, from a user device, an indication of a request for a fleet insurance product for a fleet of vehicles;
determining a base premium for the fleet insurance product;
providing, to the user device, a plurality of menu-selectable options, each option representing at least one rule representing at least one of how and when a monitoring parameter relevant to the fleet insurance product is to be monitored;
receiving, from the user device, an indication of a user selection of at least one of the plurality of menu-selectable options;
determining, based on the user selection, an adjusted premium for the fleet insurance product;
providing, to the user device, an indication of the adjusted premium for the fleet insurance product; and
facilitating, based on the adjusted premium, a sale of the fleet insurance product to a client.

22. An interface, comprising:
a first plurality of menu-selectable options, each first option representing a type of vehicle in a fleet of vehicles and each first option having associated therewith:
a second plurality of menu-selectable options, each second option representing at least one group of rules representing at least one of how and when a monitoring parameter relevant to a fleet insurance product is to be monitored, wherein the monitoring parameter comprises a plurality of metrics descriptive of a characteristic of the respective type of vehicle in the fleet of vehicles; and
a fleet insurance product premium output area, the fleet insurance product premium output area being responsive to a selection of at least one of the first or second options such that any change to the insurance product premium based on (i) the selection of the at least one of the first or second options and (ii) a plurality of stored premium determination rules, is output to a business client via the fleet insurance product premium output area.

23. The interface of claim 22, wherein the interface is provided to the business client via a specially-programmed application executed via a fleet management software application.
